(19) United States
(12) Patent Application Publication
(10) Pub. No.: US 2022/0067859 A1
(43) Pub. Date: Mar. 3, 2022

(54) Methods, Systems and Computer Program Products for Guiding Parties Through Stages of the Litigation Process

(71) Applicant: Courtroom5, Inc., Durham, NC (US)

(72) Inventors: Sonja Ebron, Gamer, NC (US); Debra Slone, Garner, NC (US)

(21) Appl. No.: 17/462,152

(22) Filed: Aug. 31, 2021

Related U.S. Application Data
(60) Provisional application No. 63/073,096, filed on Sep. 1, 2020.

(51) Int. Cl. G06Q 50/18; G06F 16/93; G06Q 10/10

(52) U.S. Cl. CPC G06Q 50/18; G06Q 10/10; G06F 16/94

(57) ABSTRACT

Methods for guiding a user through stages of a legal action are provided. The method includes receiving an update in status of a legal proceeding to update a case history of the legal proceeding; providing information from an agent based on the update in status of the legal proceeding; training the user on relevant portions of the legal proceeding based on the information provided from the agent; receiving facts related to the legal proceeding and analyzing the relevant portions of the legal proceeding based on the received facts and training to provide analysis results; preparing a document for filing with a court presiding over the legal proceeding using the analysis results; and repeating the receiving an update, providing information, training the user, receiving facts and analyzing portions of the legal proceeding and preparing the document for every stage of the legal proceeding until an indication of a terminating event is received. At least one of the repeating the receiving an update, providing information, training the user, receiving facts and analyzing portions of the legal proceeding and preparing the document is performed by at least one processor.

### CLAIM OF PRIORITY

The present application claims priority to U.S. Provisional Application Ser. No. 63/073,096, filed on Sep. 1, 2020, entitled Methods, Systems and Computer Program Products for Guiding Pro Se Parties through the Legal Process, the contents of which is hereby incorporated herein by reference as if set forth in its entirety.

### FIELD

Embodiments of the present inventive concept relate generally to legal proceedings and, more particularly, to providing a platform that allows unrepresented parties adequate access to the legal system.

### BACKGROUND

Lawsuits are filed every day in every jurisdiction in the United States and worldwide. When a person is arrested, served with a civil complaint, or is thinking about filing a civil complaint, the first thing most people investigate is legal representation. After investigation, many people are unable to afford legal representation. For criminal defendants, a public defender may be assigned, or the defendant may represent themselves. People who are sued in civil court or arrested may not have enough money to hire an attorney to defend them, and people who desire to sue in civil court may not have enough money to hire an attorney to represent them. Individuals who represent themselves in a court of law are generally at a distinct disadvantage due to lack of knowledge of the law, procedures, and the like. Easier access to information about the law, court protocols, civil procedure, and the like is desired.

### SUMMARY

Some embodiments of the present inventive concept provide methods for guiding a user through stages of a legal action. The method includes receiving an update in status of a legal proceeding to update a case history of the legal proceeding; providing information from an agent based on the update in status of the legal proceeding; training the user on relevant portions of the legal proceeding based on the information provided from the agent; receiving facts related to the legal proceeding and analyzing the relevant portions of the legal proceeding based on the received facts and training to provide analysis results; preparing a document for filing with a court presiding over the legal proceeding using the analysis results; and repeating the receiving an update, providing information, training the user, receiving facts and analyzing portions of the legal proceeding and preparing the document for every stage of the legal proceeding until an indication of a terminating event is received. At least one of the repeating the receiving an update, providing information, training the user, receiving facts and analyzing portions of the legal proceeding and preparing the document is performed by at least one processor.

In some embodiments, receiving facts related to the legal proceeding is followed by presenting statutes, rules of procedure and appellate opinions relative to the analysis results and training.

Related systems and computer program products are provided.

### BRIEF DESCRIPTION OF THE DRAWINGS

FIG. 1 is a diagram of a data processing system for use with the legal toolbox module in accordance with some embodiments of the present inventive concept.

FIG. 2 is a more detailed block diagram of a data processing system of FIG. 1 in accordance with some embodiments of the present inventive concept.

FIG. 3 is a diagram illustrating an example system including a legal toolbox module in accordance with some embodiments of the present inventive concept.

FIGS. 4 through 20 are screen shots of the legal toolbox module that illustrate examples in accordance with some embodiments of the present inventive concept.

FIG. 21 is a simple flow diagram illustrating how a user is assisted through a civil case in accordance with some embodiments of the present inventive concept.

FIG. 22 is a flowchart illustrating a specific scenario of guiding a user through a civil case in accordance with some embodiments of the present inventive concept.

FIG. 23 is a workflow diagram that can be used for training during a cycle in the discovery stage in accordance with some embodiments of the present inventive concept.

FIG. 24 is a workflow diagram illustrating an example process of adding a Count (claim or defense) in accordance with some embodiments of the present inventive concept.

FIG. 25 is a detailed workflow diagram illustrating a process for adding a Count (claim or defense) in accordance with some embodiments of the present inventive concept.

FIG. 26 is a simple workflow diagram illustrating an example Laws feature, which helps the user find statutes and appellate cases in accordance with some embodiments of the present inventive concept.

FIG. 27 is a workflow diagram illustrating an example process for document creation in accordance with some embodiments of the present inventive concept.

FIGS. 28 through 42 are diagrams illustrating a specific scenario of using the legal toolbox in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For many decades, the United States has had a crisis involving “access to justice.” The access to justice crisis is that people who are represented by a lawyer have much higher legal success rates than those who cannot afford one or are represented by a lawyer appointed to them. The problem disproportionately affects African Americans, Hispanics, the poor, and women. Unable to afford a lawyer or qualify for aid, many have no choice but to handle cases on their own.

Each year, upwards of 30 million people represent themselves in state courts. They appear in potentially life-altering legal cases, including child custody, eviction, deportation, foreclosure, debt/bankruptcy and the like. In so many instances, they face a lawyer on the other side and lose the very things they came to protect.

The average self-represented litigant has little knowledge of civil procedure, no legal skills, and a misunderstanding of real litigation. They need help. But, over the years, the legal profession has dealt with this problem by offering a single solution—provide lawyers for everyone who needs them. This solution has failed miserably because only 10% of people can afford to hire a lawyer. Further, prior systems either work only for lawyers, do not involve complex cases, provide forms that cannot be customized, or limit services to one claim type rather than the broader area of legal procedure. Accordingly, embodiments of the present inventive concept provide methods for improving the overall performance of pro se parties in complex civil cases by guiding them through the legal procedure process.

As discussed above, generally people who cannot afford legal representation are at a disadvantage in a “legal proceeding,” civil or criminal. As used herein, a “legal proceeding” refers to any aspect of a criminal or civil action where legal representation by a licensed attorney is generally sought. Although many of the examples discussed herein refer to civil proceedings in the United States, embodiments of the present inventive concept are not limited thereto. For example, aspects of the present inventive concept may be used by a criminal defendant as well as parties in foreign jurisdictions without departing from the present inventive concept.

An average person does not generally understand the law or have the ability to learn about the law in a constructive or timely manner to adequately represent themselves in a legal proceeding. Lack of knowledge of procedures alone can lead to failure. Accordingly, some embodiments of the present inventive concept provide an end-to-end “legal toolbox” for people who do not have representation, as will be discussed further herein.

As used herein, the “legal toolbox” refers to a series of modules directed to case management; gaining legal skills; communication with peer groups, and the like. Furthermore, the legal toolbox offers tips on representing oneself in a courtroom. The tips may include documents discussing (1) The burden of proof in a civil case; (2) How to assert affirmative defenses; (3) How to plead a condition precedent to a claim and the like. It will be understood that the legal toolbox does not provide legal advice, but information for those who do not have legal representation. The information may be provided in the form of templates, links, flowcharts, infographics, videos and the like, but at no point does the legal toolbox provide actual legal work product or advice associated therewith. Embodiments of the present inventive concept provide access to the legal system, its laws and procedures that allow an unrepresented person to successfully navigate the legal proceeding and obtain a more positive outcome, as will be discussed further below.

It will be understood that although embodiments of the present inventive concept are generally directed to a person or persons who represent themselves in a courtroom, for example, a plaintiff or defendant in a civil suit or a defendant in a criminal action, embodiments of the present inventive concept are not limited to this configuration. For example, some embodiments of the present inventive concept may be used as training materials for those who are working to become lawyers, paralegals and the like without departing from the scope of the present inventive concept.

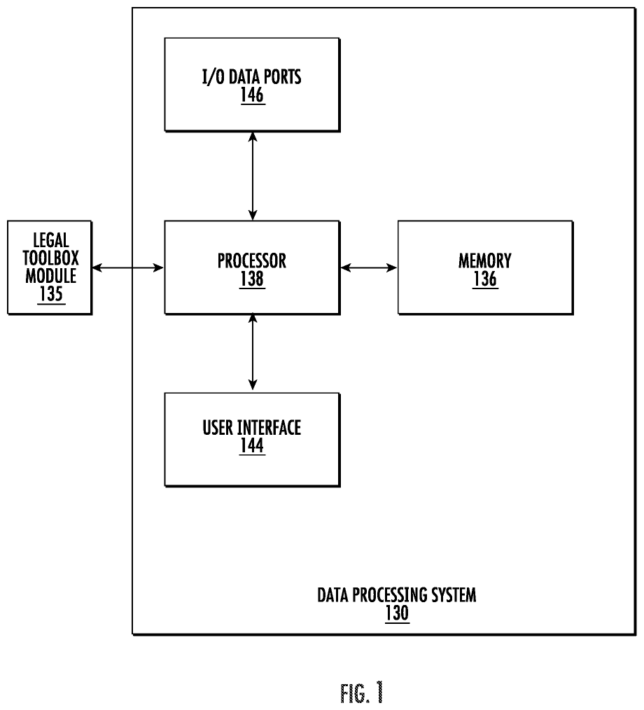

Referring now to FIG. 1, a high level block diagram of a data processing system 130 that may be used in accordance with some embodiments of the present inventive concept will be discussed. As illustrated in FIG. 1, the legal toolbox module 135 in accordance with embodiments discussed herein communicates with a data processing system 130. The data processing system 130 in FIG. 1 is provided as an example data processing system configured in accordance with embodiments of the present inventive concept. As further illustrated, the data processing system 130 may include a user interface 144, including, for example, checkboxes, radio buttons, buttons, labels, sliders, dropdown lists, and text boxes, and may require input device(s) such as a keyboard or keypad, a display, touch display, a speaker and/or microphone, and a memory 136 that communicate with a processor 138. The data processing system 130 may further include I/O data port(s) 146 that also communicates with the processor 138. The I/O data ports 146 can be used to transfer information between the data processing system 130 and the cloud, another device, computer system or a network using, for example, an Internet Protocol (IP) connection. An example device is a court docket system. These components may be conventional components such as those used in many conventional data processing systems, which may be configured to operate as described herein. Communication from the data port(s) 146 may be wireless communication in some embodiments.

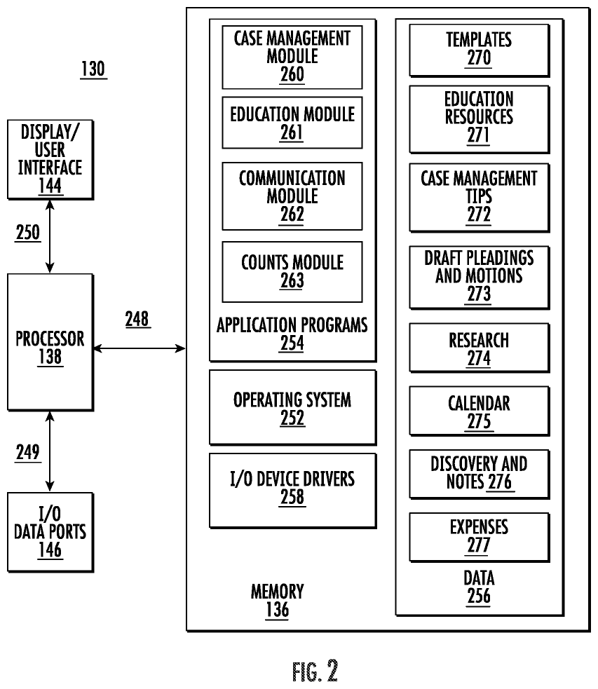

Referring now to FIG. 2, a more detailed block diagram of a data processing system 130 of FIG. 1 is provided that illustrates methods, systems, and computer program products for guiding pro se (unrepresented) parties through the legal process in accordance with some embodiments of the present inventive concept will now be discussed. As illustrated in FIG. 2, the processor 138 communicates with the memory 136 via an address/data bus 248, the I/O data ports 146 via address/data bus 249 and the electronic display/user interface 144 via address/data bus 250. It will be understood that the communication over busses 248, 249 and 250 are not limited to wired communication, but could be wireless in accordance with some embodiments of the present inventive concept. Thus, it will be understood that FIG. 2 is provided for example only and that embodiments of the present inventive concept are not limited thereto.

Furthermore, the processor 138 can be any commercially available or custom enterprise, application, personal, pervasive and/or embedded microprocessor, microcontroller, digital signal processor or the like. The memory 136 may include any memory device containing the software and data used to implement the functionality of the data processing system 130. The memory 136 can include, but is not limited to, the following types of devices: ROM, PROM, EPROM, EEPROM, flash memory, SRAM, DRAM as well as storage in the cloud.

As further illustrated in FIG. 2, the memory 136 may include several categories of software and data used in the system: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP, or Windows CE or Windows 7 from Microsoft Corporation, Redmond, Wash., Palm OS, Symbian OS, Cisco IOS, VxWorks, Unix or Linux and/or Android or IOS for mobile devices. The I/O device drivers 258 typically include software routines assessed through the operating system 252 by the application programs 254 to communicate with devices such as the I/O data port(s) 246 and certain memory 136 components. The application programs 254 are illustrative of the programs that implement the various features of some embodiments of the present inventive concept and may include at least one application that supports operations according to embodiments of the present inventive concept. Finally, as illustrated, the data 256 may include any of the data acquired and stored by the system, which may represent the static and dynamic data used by the application programs 254, the operating system 252, the I/O device drivers 258, and other software programs that may reside in the memory 136.

As illustrated in FIG. 2, the data 256 may include templates 270; education resources/courses and workshops 271; case management tips/information sheets/sample documents 272; draft pleadings and motions 273 created and stored by the user; research 274; calendar information 275 and associated tasks; discovery and notes 276 and expenses 277. Each of these the data 256 illustrated in FIG. 2 will be discussed below. It will be understood that the data files provided in FIG. 2 are provided as examples only and that embodiments of the present inventive concept are not limited thereto. Two or more of the data files may be combined, one of the data files may be split in two or additional data files may be added without departing from the scope of the present inventive concept.

As further illustrated in FIG. 2, according to some embodiments of the present inventive concept, the application programs 254 include a case management module/Toolset 260, an education module 261, a communication module 262 and a counts module 263. While the present inventive concept is illustrated with reference to the case management module/Toolset 260, the education module 261, the communication module 262 and the counts module 263 being application programs in FIG. 2, as will be appreciated by those of skill in the art, other configurations fall within the scope of the present inventive concept. For example, rather than being application programs 254, these circuits and modules may also be incorporated into the operating system 252 or other such logical division of the data processing system. Furthermore, while the case management module/Toolset 260, the education module 261, the communication module 262 and the counts module 263 are illustrated in a single system, as will be appreciated by those of skill in the art, such functionality may be distributed across one or more systems. Thus, the present inventive concept should not be construed as limited to the configuration illustrated in FIG. 2, but may be provided by other arrangements and/or divisions of functions between data processing systems. For example, although FIG. 2 is illustrated as having various circuits, one or more of these circuits may be combined without departing from the scope of the present inventive concept.

It will be understood that the case management module/Toolset 260, the education module 261, the communication module 262 and the counts module 263 may be used to implement various portions of the present inventive concept capable of being performed by a data processing system as will be discussed below. It will be understood that the case management module/Toolset 260, the education module 261, the communication module 262 and the counts module 263 combined may be termed the legal toolbox module 135 as discussed above. The legal toolbox module 135 has been split into the case management module/Toolset 260, the education module 261, the communication module 262 and the counts module 263 in FIG. 2 to allow explanation of the various functionalities provided by the legal toolbox module 135. It will be understood that these four modules may be combined into one, two or three modules or split into more than four modules without departing from the scope of the present inventive concept. For example, the counts module 263 that is configured to help users identify claims and defenses may be incorporated with one of the other three modules without departing from the scope of the present inventive concept.

Utilizing the modules of the application programs 254 and the data filed in the data 256 and data discussed above with respect to FIG. 2, embodiments of the present inventive concept provide a user-friendly interface that allows unrepresented individuals to gain the knowledge of the laws and procedure to handle their legal proceedings and possibly provide a positive outcome thereto.

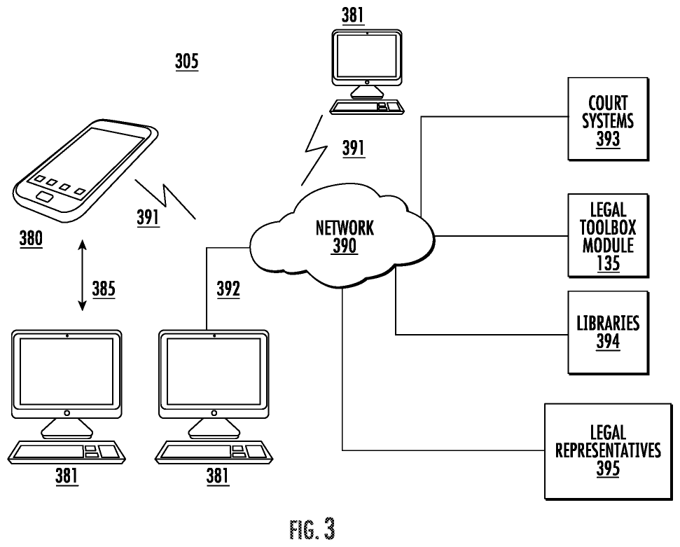

Referring now to FIG. 3, a system 305 including a legal toolbox module 135 in accordance with some embodiments of the present inventive concept will be discussed. As discussed above, FIG. 2 illustrates the various modules and data that may make up the legal toolbox module 135 and thus, FIG. 3 will be discussed with respect to these aspects of FIG. 2 below. As illustrated in FIG. 3, the system 305 includes a plurality of devices 380 and 381, a network 390 and various destinations, including, court systems 393; the legal toolbox 135 as discussed herein, libraries 394 (case law, precedent etc.) and legal representatives 395. The devices can be mobile 380 or stationary 381 and communicate both wirelessly 391 and over a physical connection 392. In some embodiments, the mobile devices 380 may be equipped with a mobile application version of the legal toolbox. The devices 380 and 381 may be used to access the toolbox module 135 in accordance with embodiments discussed herein as well as the various court systems 393, libraries 394 and legal representative 395 associated therewith. Furthermore, use of the legal toolbox module discussed herein allows users to communicate with one another as indicated by arrow 385. Users can discuss their legal proceedings, ask each other questions and the like. It will be understood that the system of FIG. 3 is provided for example only and that embodiments of the present inventive concept are not limited thereto. For example, there may be more destinations, more or less devices 380 and 381 and more then one network 390 without departing from the scope of the present inventive concept. Furthermore, although FIG. 3 shows the toolbox module 135 being separate from the court systems 393, libraries 394 and the legal representatives 395, it will be understood that the toolbox module 135 is the conduit that allows the users to access these destinations.

For example, a user using a device 380/381 may connect to the legal toolbox module (details will be discussed below) and begin using the tools to deal with or respond to a task associated with the user's legal proceeding. On average, each party in a legal proceeding performs nearly 200 separate tasks during the duration of the legal proceeding. Embodiments of the present inventive concept provide customized graphical user interfaces (GUIs) to walk the pro se party (the party without representation) through a series of decisions in each stage of the legal proceeding. The stages may include a complaint stage; an answer stage; a discovery stage; a pre-trial and trial stage and an appeal stage. It will be understood that not all legal proceedings go through every stage as a legal proceeding may settle at any time. As used herein, “settlement” refers to an agreement between the parties that is not mandated by the fact finder.

In some embodiments, the legal toolbox 135 may allow the user to connect to the system associated with the court 393 in which the legal proceeding is pending and view a status of the case and the associated tasks associated therewith. In some embodiments, the legal toolbox 135 may allow the user to automatically calendar events associated with the legal proceeding and may get automatic updates from the court system 393 if an action is taken by any party to the legal proceeding. For example, in some embodiments, the legal toolbox 135 may be configured to do a “scrape” of the court systems dockets and look for anything associated with the user's legal proceeding. If the scrape returns a match for the user's legal proceeding, the user's calendar or documents associated with the legal proceeding may be automatically updated. For example, if the opposing party files an answer to the user's complaint, the toolbox module 135 may download a copy of the answer and calendar the due date for any response or request for extension of time.

Furthermore, conventionally, lawyers provide legal representation for an entire legal proceeding, which can be very expensive and may not be affordable for the user. Thus, some embodiments of the present inventive concept may allow the user to develop a client relationship with a legal representative 395 (not associated with the legal toolbox module). This legal representative may provide unbundled services to the user. In other words, the legal representative may only provide their services for a particular portion of the legal proceeding, for example, the trial. Providing unbundled legal services may make the process more affordable and may allow the user to obtain legal representation for the more complicated aspects of the legal proceeding.

Referring again to FIG. 3, the user may also have access to libraries 394 including templates, tips and the like that guide the user through various aspects of the legal proceedings. Embodiments of the present inventive concept are not limited to unrepresented (pro se) parties. A user who has legal representation may use embodiments of the present inventive concept to further understand the action his/her legal representative is taking in the legal proceeding. Similarly, a criminal defendant may use embodiments of the present inventive concept to make sure his/her court appointed lawyer, who are often overworked, is doing the best job he/she can. Thus, even if a user is utilizing the systems provided by the legal toolbox module it is always a good idea to contact a lawyer or your legal aid office immediately if you have a legal emergency, like divorce and custody cases, foreclosures, debt, and probate matters, you name it.

Some embodiments of the present inventive concept provide various “toolsets.” The toolsets are tailored to the specific type of legal proceeding the user is involved in. For example, a litigator's toolset may aid the user in drafting and printing professional legal documents from a template library (templates 270—FIG. 2); find and capture relevant statutes and case law; keep track of tasks associated with the legal proceeding; access case filings and evidence anywhere; manage expenses associated with the legal proceeding; avoid mistakes that pro se applicants typically make; proceed intelligently, and the like.

Because the legal toolbox module 135 is not intended to replace a lawyer providing legal advice, the templates 270 are generic, but the user may be walked through the laws and rules of civil procedure for their particular jurisdiction. In other words, the user may be provided with a user interface that allows the user to enter specific information associated with the user's legal proceeding and the user interface is configured to provide the “next steps” based on the information entered by the user. A detailed example of the GUI and the operations thereof will be discussed below.

Some embodiments of the present inventive concept facilitate the user with analyzing his/her legal proceeding and that of their opponent (case management module/Toolset 260, FIG. 2). A user may be given information on elements of claims or defenses in their jurisdiction; determine discovery questions, responses, and objections and the like. As discussed above, the user may have access to templates that may be used to draft pleadings and motions related to the legal proceeding. The drafts may be edited and saved by the user (273 of FIG. 2). Once they are completed, the documents may be download and printed in a format that is accepted by the relevant jurisdiction and be signed and filed.

Some embodiments of the present inventive concept provide a pro se-friendly legal research tool (education module 261, FIG. 2) which is configured to help the user find case law, statutes, and other authorities that are relevant to the user's legal proceedings. The research tool may help the user organize their arguments and related citations such that these can be easily pasted into the user's motions/pleadings. Again, the user may store the research results making them easy to find at a later date (274, FIG. 2).

Some embodiments of the present inventive concept (case management module/Toolset 260, FIG. 2) assist the user in maintaining a record of the legal proceeding that is accessible by the user at any time. As discussed above, the user may access the details of their proceeding using a mobile device and the user may have a calendar (275, FIG. 2) for the legal proceeding stored thereon.

The case management module/Toolset 260 may be further configured to help collect and organize evidence for the legal proceeding. This evidence/discovery may be stored in, for example, PDF or image formats, and the user may include notes with each including related facts and elements (276, FIG. 2). Again, this information is accessible the user anytime it is needed.

The case management module/Toolset 260 may be configured to facilitate planning major tasks associated with the legal proceedings, for example, organized by the stage of your case (calendar, 275, FIG. 2). The user may track progress of task as well, for example, there may be an indication of in progress, percentage complete, completed, deferred or the like on a user's account associated with each task/document. The user may also schedule events, for example, hearings and filing deadlines, and set reminders as needed.

Some embodiments of the present inventive concept provide a space for users to keep notes that capture thoughts and miscellaneous details about the legal proceeding (276, FIG. 2). These notes may be further categorized based on, for example, the stage of the legal proceeding. These notes may be copied and pasted to various documents with the user's account as a convenience.

As discussed above, it is a good idea to keep a running total of the user's costs no matter which side of the legal proceeding the user is on. If the user is the defendant and the user prevails, the user may request that his/her expenses be reimbursed. These expenses may be categorized, for example, copies, parking, postage, travel and the like.

As discussed above, some embodiments of the present inventive concept make various education materials available to the user. The education module (261, FIG. 2) is configured to allow users to learn to represent themselves effectively using, for example, animated video courses and live and video workshops (education resources 271, FIG. 2). The education module 261 helps users to build skills needed to navigate the various aspects of legal proceedings at each stage of the legal proceedings and to understand civil procedure and the law.

For example, some embodiments of the present inventive concept provide an educational resource directed to the basics of a civil litigation. This resource may include details with respect to all stages of a civil proceeding, for example, the complaint stage, answer stage, discovery stage and trial stage.

Some embodiments of the present inventive concept may provide an educational resource directed to introducing a user to legal skills. For example, these resources may be directed to developing a legal strategy; basic legal writing; crafting a legal argument; and court protocol.

Some embodiments of the present inventive concept provide an educational resource directed to introducing a user to the rules of civil procedure. For example, these resources may include information directed to civil procedure at the complaint stage; civil procedure at the answer stage; civil procedure at the discovery stage; and civil procedure at the trial stage.

Some embodiments of the present inventive concept provide an educational resource directed to legal research and authorities. These resources may include information related to statutes, codes and rules; appellate opinions (Case Law); local rules and course handbook.

It will be understood that the educational resources discussed above are provided as examples only and that many other types of education resources may be provided in accordance with some embodiments of the present inventive concept.

Some embodiments of the present inventive concept may provide educational opportunities in the form of workshops. These workshops may be in person, virtual or on-demand. These workshops may be directed to any aspect of self-representation. For example, the workshops may be directed to popular litigation topics or to fill any gaps left by other courses. Recorded workshops may, for example, provide one-hour lessons on a single topic. The live sessions provide an opportunity to ask questions of instructors and other members. For example, some available workshops include Not Judge Judy's Court covering managing a civil case as a pro se litigant; the civil litigation process: theory versus practice; using the legal toolbox discussed herein to supercharge your case; and oral argument and settlement negotiations for pro se litigants.

Others include:
Finding Legal Authorities, including determining legal issues relevant to your search; finding cases and statutes that speak to the issues; discarding cases that are not relevant; and capturing cases and statutes for easy citation and summary.
Case Killing Motions, covering the motion for default judgment; the motion to dismiss; the motion for summary judgment; and the motion for judgment as a matter of law.
Proving your Case, covering collecting evidence through discovery; responding to discovery requests; authentication and admissibility; and presenting evidence in court.
How to Litigate, covering the process of litigation, including journey to justice-steps; only two questions at each step; litigation process at each step; and examples for each step.

The workshops discussed above are provided as examples only and, therefore, embodiments of the present inventive concept are not limited thereto.

Some embodiments of the present inventive concept facilitate communication between and among the users (communication module 262, FIG. 2). This community of users may give and receive encouragement and peer advice. This communication module may be used to ask common questions, such as, the right time to move for summary judgment, the number of times a complaint can be amended, filing a motion for sanctions or to compel discovery, suggested language in requests for production, and the like. Thus, although the users are not given legal advice, they can benefit from the experience of others.

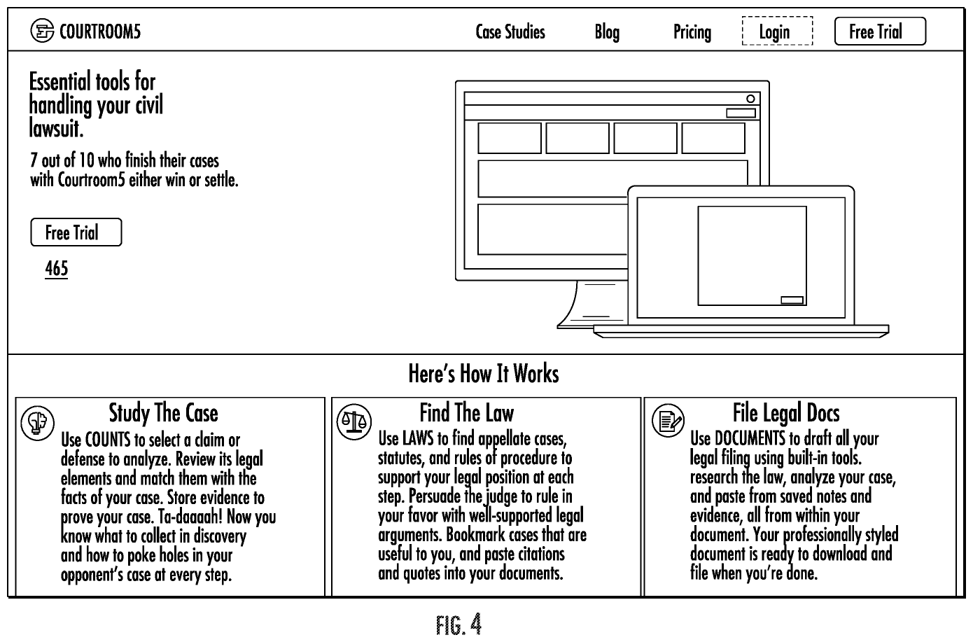

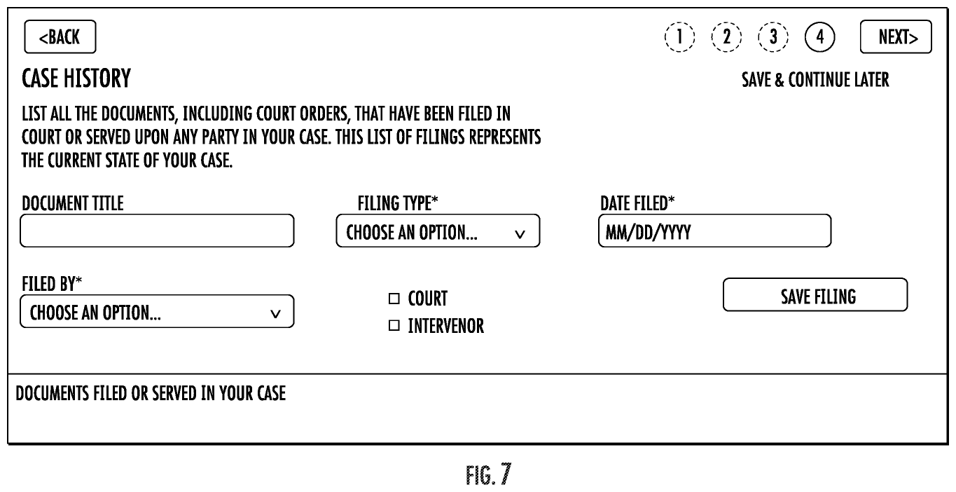

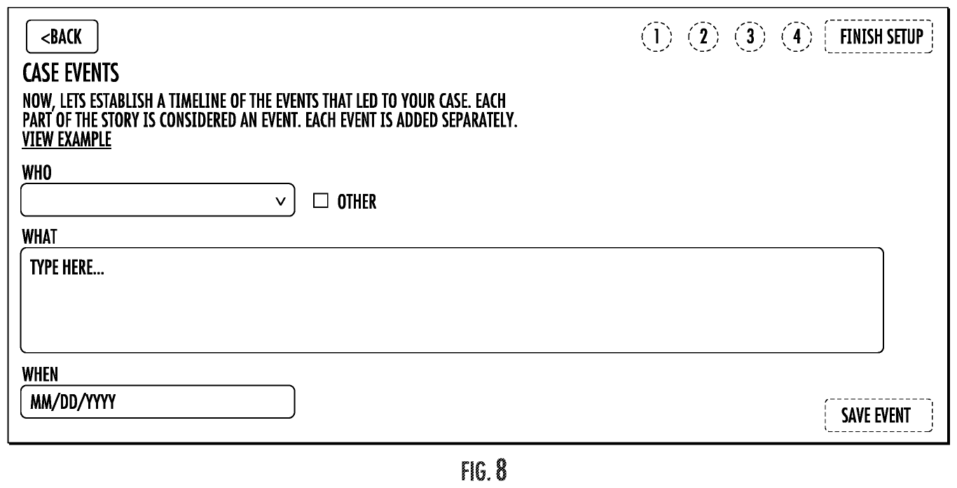

An example user experience will now be discussed with respect to FIGS. 4 through 20. It will be understood that this example is provided for purposes of illustration only and, therefore, embodiments of the present inventive concept are not limited thereto.

Referring first to FIG. 4, a screen shot of a welcome screen for the legal toolbox module will be discussed. A user may navigate to a portal for the legal toolbox module 135 in accordance with some embodiments of the present inventive concept. As illustrated in FIG. 4, the user may access information about the module 135 and how it works by selecting tabs: “case studies;” “pricing;” etc. This will help them evaluate the toolbox and their options before subscribing. For example, the user may select the “free trial” button 465 on the portal and get full access to the system during a trial period.

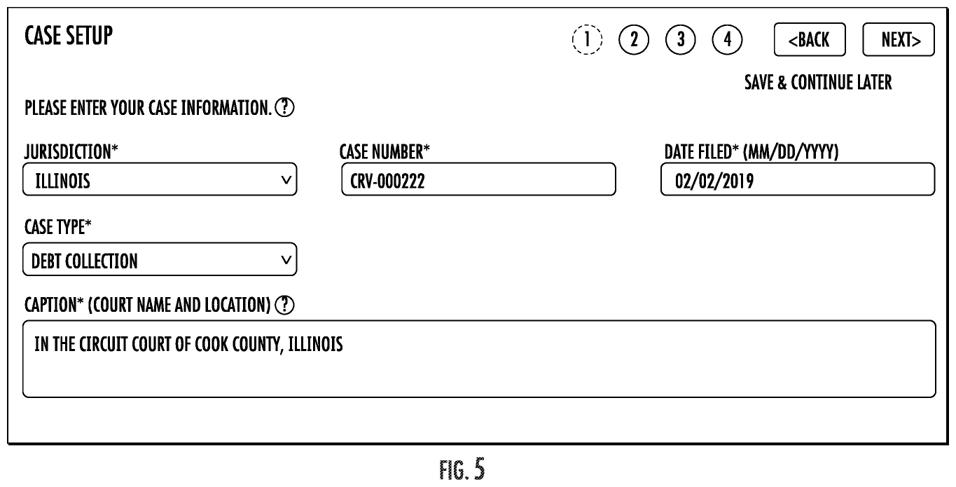

As shown in FIG. 5, once the user selects “free trial” 465 (FIG. 4), the system will guide them through account creation. In account creation, the user will first provide information about the case, including case number and court. In some embodiments, the tool may be configured to use the case number to obtain the information from the court system. In other words, the details of the proceeding may be “scraped” from the court system and this information may be used to populate the user's account, including calendar dates and task.

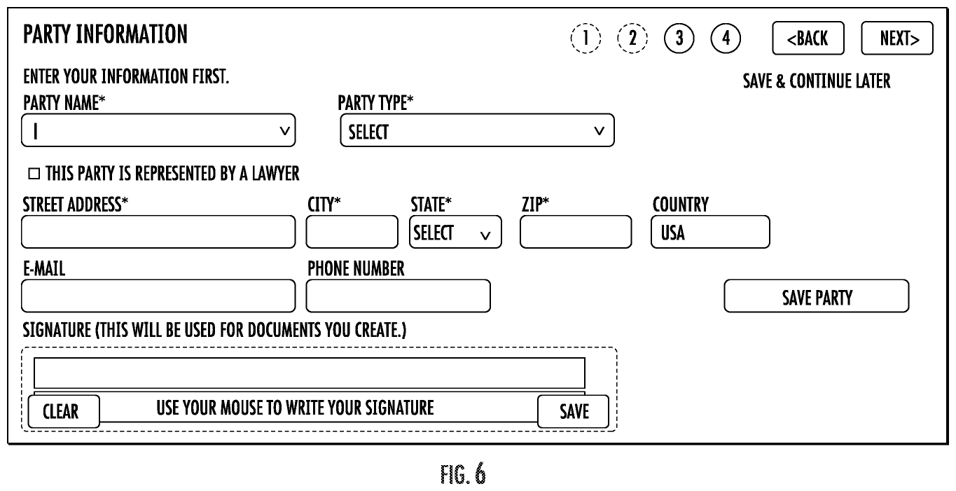

Next, as illustrated in FIGS. 6, 7, and 8, the user provides information about the parties, including names and email addresses; case history information about the most recent document filed; and information about the events that led to the filing of the case (case events).

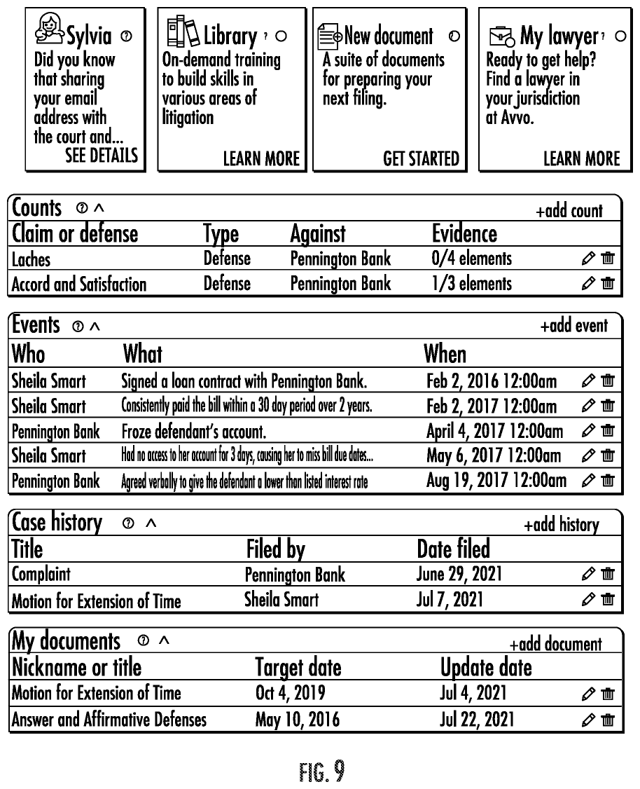

An example user dashboard or landing page is illustrated in FIG. 9. As illustrated in FIG. 9, from the dashboard, the user has access to the AI bot (AI agent) with pointers; a library of courses; a claims and defenses table (counts); documents, and the like. FIG. 9 is provided as an example only and embodiments of the present inventive concept are not limited thereto.

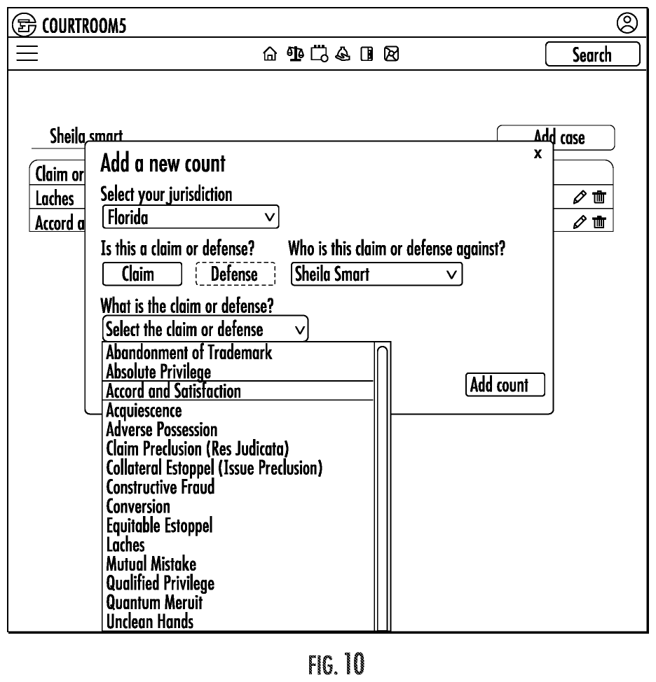

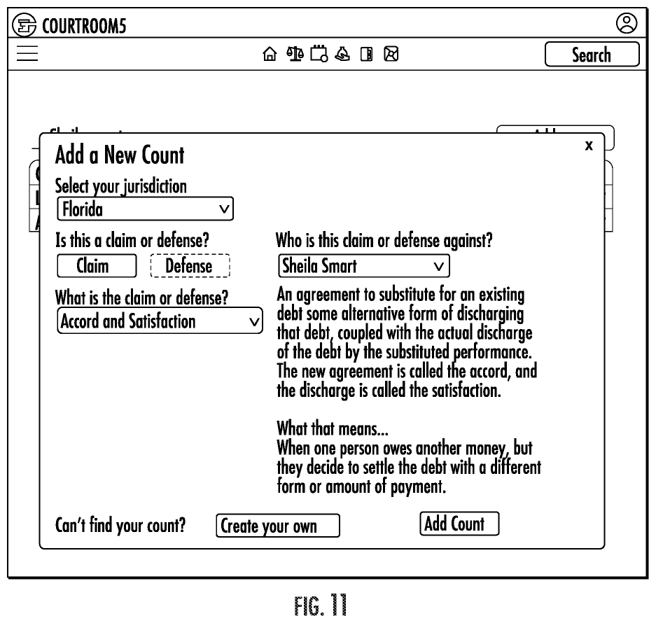

As illustrated in FIG. 10, to add a claim or defense, the user clicks “+Add Count” on the “Counts” table of the dashboard. A “Counts” box will appear, as shown in FIG. 11, and the user can select “claim” or “defense”. The can then select the party that the claim or defense is against. Depending on which the user chooses, the table populates with claims in the selected jurisdiction or defenses in the selected jurisdiction. The user selects a specific claim or defense (i.e. laches, defamation etc.), and a sentence defining the claim or defense is shown. Again, it will be understood these examples and the orders in which items are selected are provided for example only and embodiments of the present inventive concept are not limited thereto.

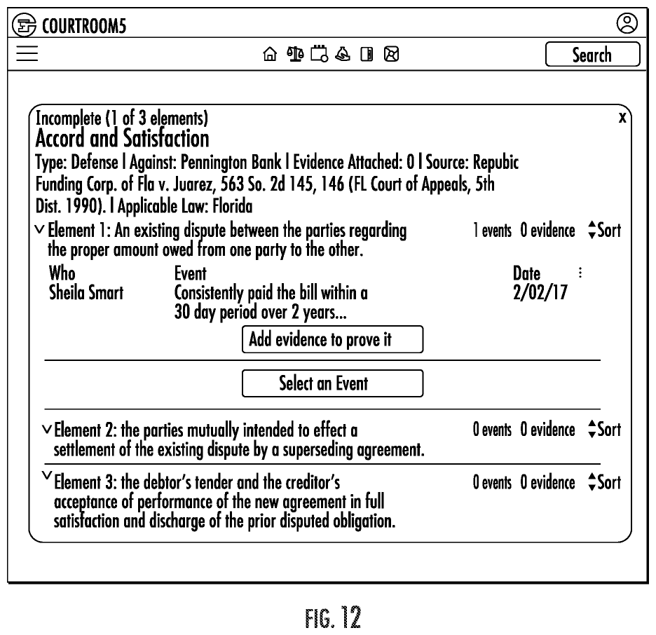

In FIG. 12, the system presents a list of the elements required to prove the chosen claim or defense, and a source where the elements are provided from. The user can match up events in the case to each of the elements, upload, and describe supporting evidence. A counter on the dashboard tells the user how completely a claim or defense is supported. For example, if the user has 4 elements and connects events to two of them, the counter will read 2/4.

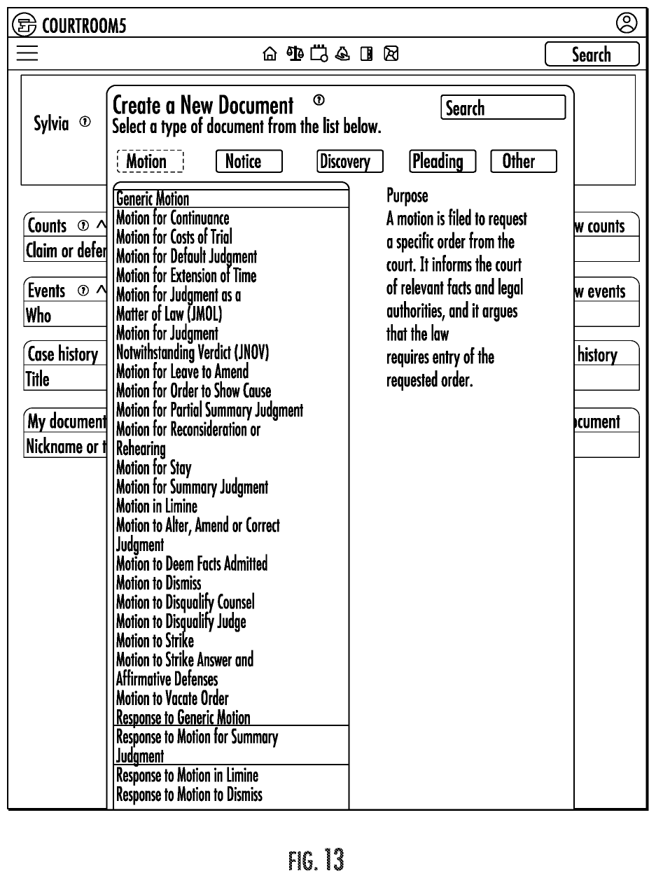

As illustrated in FIG. 9, from the dashboard, the user may also have access to the AI agent (bot), which may contain information about the next task in the case history. The dashboard may also provide easy access to the library or educational module. A user can also select “create a new document” to begin a new pleading or motion as will be discussed further below with respect to FIG. 13.

In some embodiments, actions in the tool are triggered by a “change” in the status of the user's case. For example, if something gets filed and uploaded, the information related to this change is entered. However, in some embodiments a connection may be provided to the court system that allows automatic updates when a change occurs in the status of the proceeding.

Referring now to FIG. 13, if a user selects “create a new document” from the dashboard, the user may be given a list of documents that may be created as illustrated in FIG. 13. The user may hover over the various documents and see a description of the documents “purpose” as shown in FIG. 13. The user selected “Response to Motion for Summary Judgment” and the purpose of the document is shown.

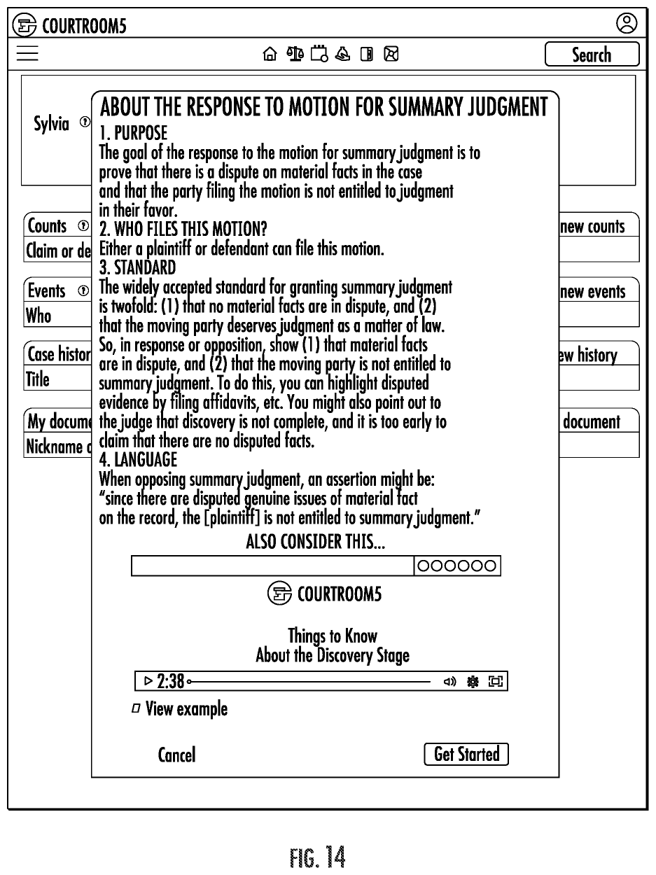

Once the user selects the response to the motion for summary judgment, the user is provided with a page that provides additional details with respect to the response to the motion for summary judgment, as illustrated in FIG. 14. The details may include information on the purpose, the standard and the language for this motion. The user can also view an example document as well as a training video relevant to where they are in the case and what they want to file.

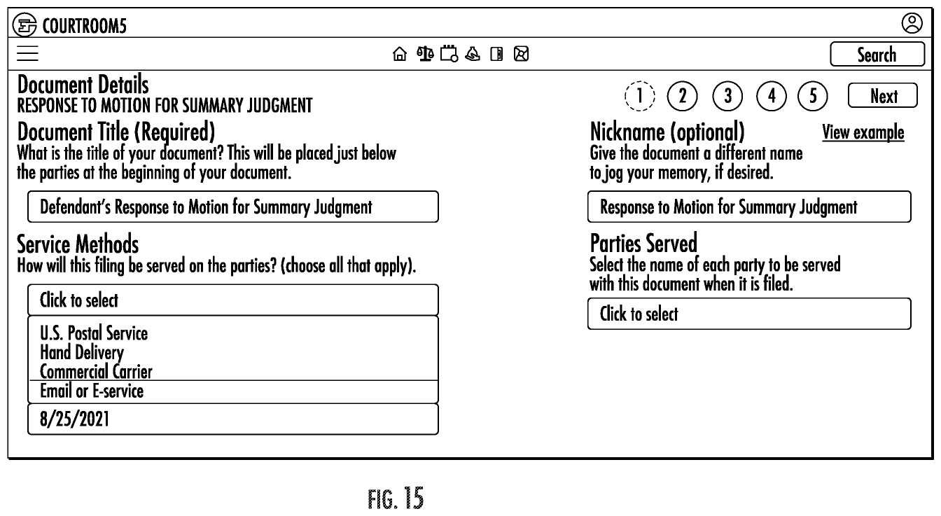

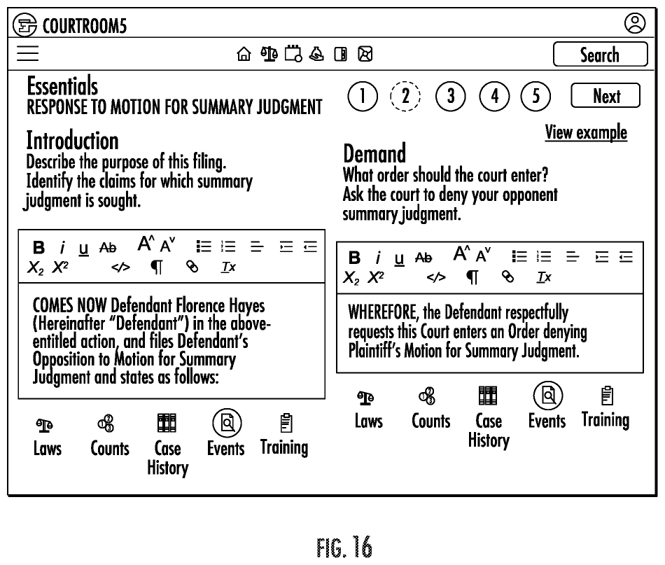

If the user chooses to move forward with this motion based on the information provided, they may be prompted to write the various sections of the motion. First, in FIG. 15, the user is presented with a page that allows the user to enter relevant information to begin drafting the documents. As illustrated therein, the user is prompted to select a document title and provide an optional nickname; a service method (e.g. USPS; hand delivery; commercial carrier; email or e-service); the parties to be served and a date on which the user would like to serve the document. As illustrated in FIG. 16, the user is prompted to draft an introduction and a demand. The tools that the user may need to access during the writing of these sections are available at the bottom of the page. The user can access other tools without leaving the draft document.

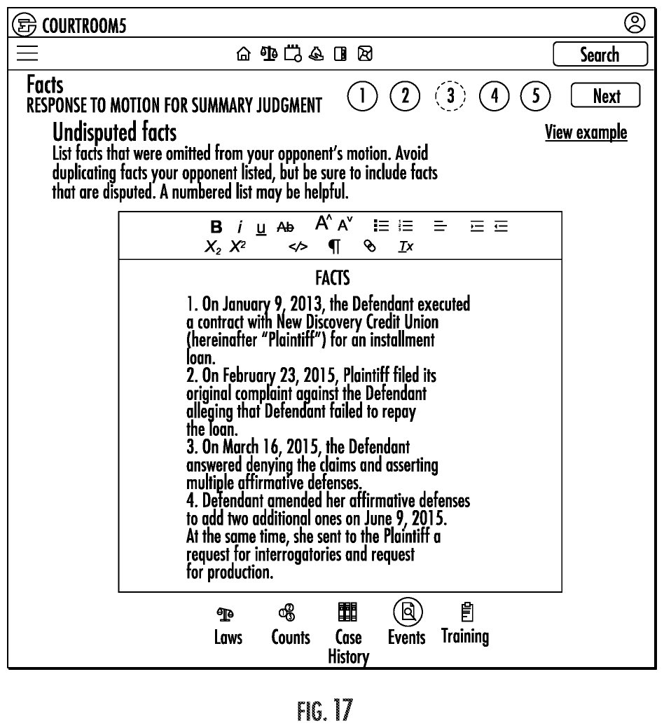

Once the introduction and demand are completed, the user may be prompted to draft a description of the facts surrounding the legal proceeding and the legal standard as shown in FIG. 17. Additional tools are available at the bottom of the page as illustrated.

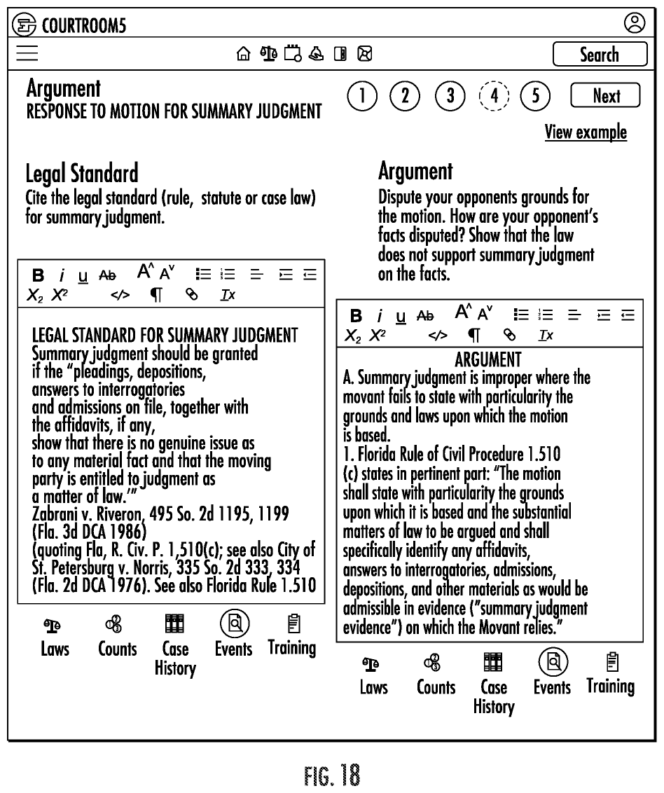

Once the facts and legal standard are addressed, the user may be prompted to draft the argument for the motion as shown in FIG. 18. The page guides the user through the process.

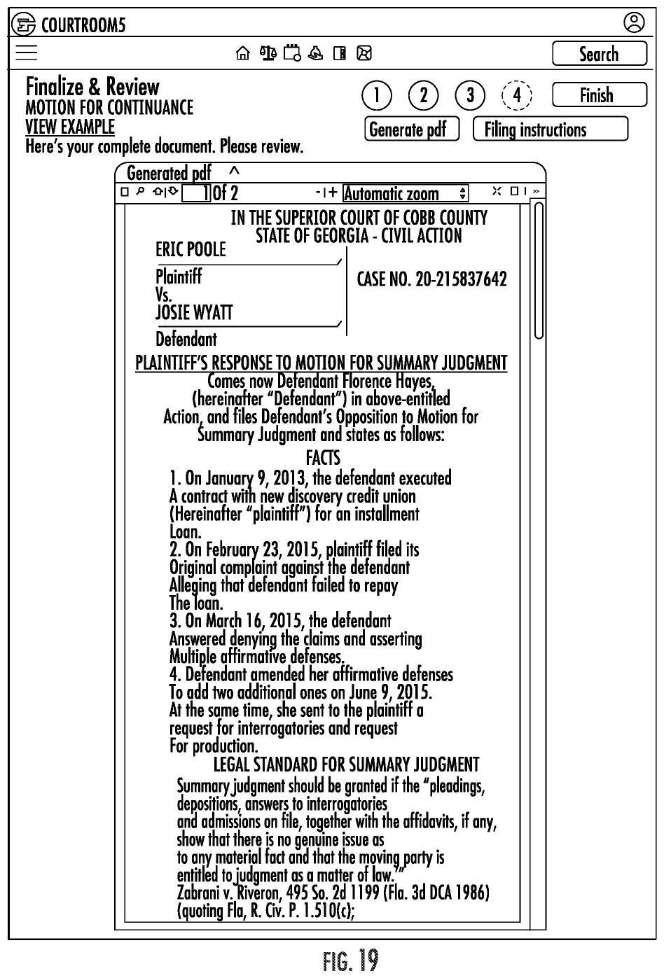

Once the user completes all the various fields to the user's satisfaction, a draft motion may be presented to the user as shown in FIG. 19. It will be understood that the user may save the motion at any point during the process as a “draft” and, therefore, may come back to the motion to revise and finalize. As illustrated, the completed motion may be formatted. It will be understood that although a draft motion is discussed herein, other documents may also be drafted, for example, notices, pleadings, discovery documents, miscellaneous filings and the like using embodiments of the present inventive concept. Some embodiments of the present inventive concept use an automatic save feature, which saves the most recent version of the documents being created.

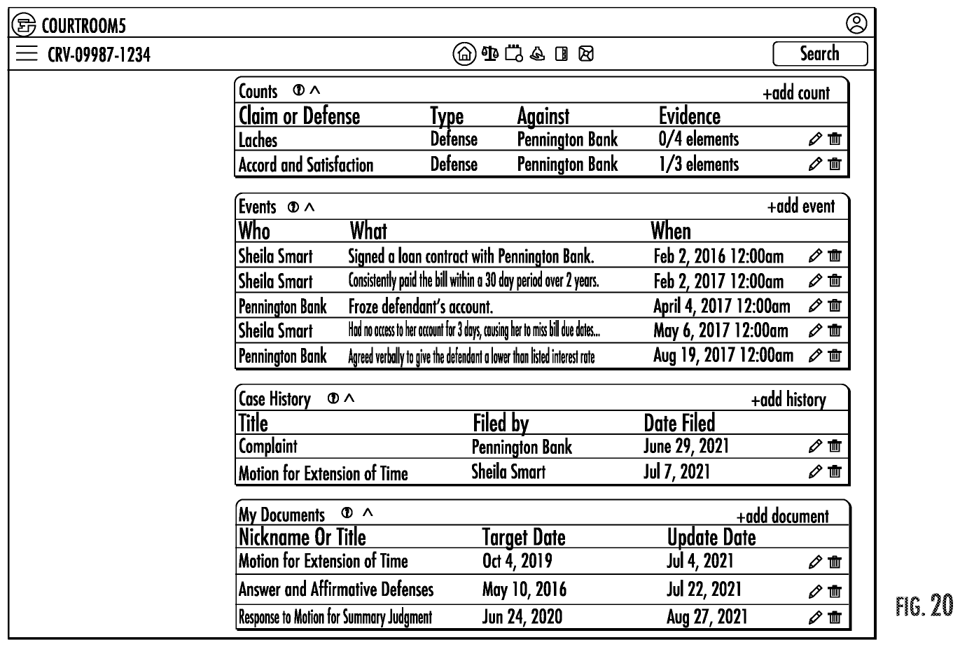

As further shown in 19, the tool may provide information on how to file and serve the completed motion. Once the motion is filed, the user dashboard may be updated as shown in FIG. 20. As illustrated, the case history row in the dashboard is populated with the new filing.

As discussed above, some embodiments of the present inventive concept may allow the user to contact a legal representative at any point during the legal proceedings. Thus, embodiments of the present inventive concept may facilitate provision of unbundled legal services. However, the tool only connects the legal representative to the user and does not provide any legal advice.

Although the example discussed with respect to FIGS. 4 through 20 relate to a civil action, embodiments of the present inventive concept are not limited thereto. Embodiments of the present inventive concept may be used for any party both with the United States and Foreign Jurisdictions without departing from the scope of the present inventive concept.

The example discussed above with respect to FIGS. 4 through 20 is discussed specifically with respect to a motion for summary judgment. As is clear from the listing on FIG. 13, many other documents may be created. Furthermore, the toolbox offers information on all aspects of the legal proceeding. In other words, the toolbox also offers information on how to respond to various actions and orders.

As discussed above, some embodiments of the present inventive concept provide a legal toolbox module that allows unrepresented individuals to better represent themselves in legal proceedings. The legal toolbox provides help with case management; allows the user to gain legal skills and to communicate with peer groups and the like. Use of the legal toolbox in accordance with embodiments discussed herein leads to a better outcome for the user.

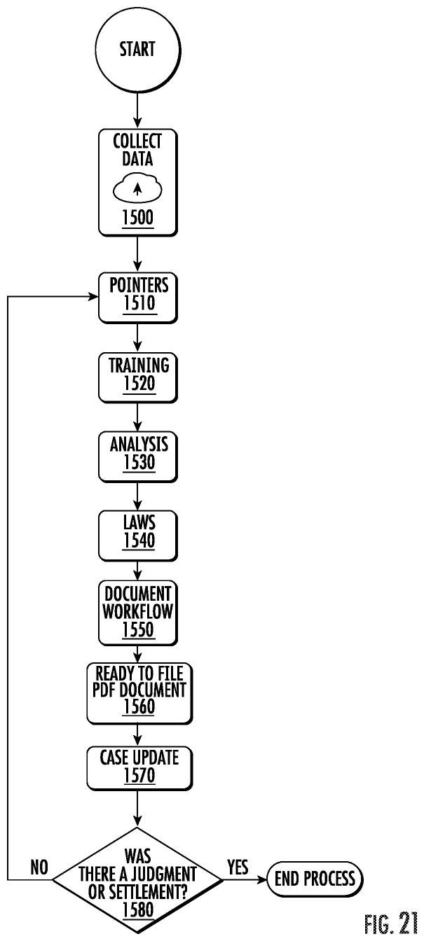

Referring now to FIGS. 21 through 27, various examples will be discussed for using the methods, systems and computer program products in accordance with some embodiments of the present inventive concept. It will be understood that embodiments of the present inventive concept are not limited to examples discussed herein. For example, although examples are discussed herein with respect to civil lawsuits, embodiments of the present inventive concept are not limited thereto. Embodiments discussed herein may be used in criminal case as well as for training purposed without departing from the scope of the present inventive concept.

As discussed above, some embodiments of the present inventive concept provide for an improved process when a user is not represented by a lawyer (non-lawyer litigation). As discussed above, the present inventive concept monitors a court case, captures the status of the case at each stage and responds with relevant training and directions for the use of specific software features. Use of the system and related method relies on an integrated system that includes, for example, artificial intelligence (AI), video lessons, a case analysis feature, a case history feature that simulates a court docket, a searchable case database, guided templates for writing lawyer-like documents and the like. Some embodiments of the present inventive concept are based on two main assumptions. The first assumption is that documents filed in a case are sufficient determinants of the stage of a case and are indicators of what the user should do next given what's been filed. The second assumption is that users can succeed in the process of civil procedure by adhering to four recommended cyclical steps, training, case analysis, legal research, and document creation. Once a document is created, the cycle repeats until the user gets a judgment or settlement as will be discussed further herein.

As discussed above, the present inventive concept relates to the field of law by providing a system that uses artificial intelligence to guide users, for example, non-lawyers or new lawyers, through the process of litigation and civil procedure at each stage in a case. As discussed above, embodiments of the present inventive concept may have potential for direct application for individuals with criminal cases, simple civil cases, new lawyers, or cases outside the United States, embodiments discussed herein are directed to a system and process for handling complex civil cases in the United States without a law degree or legal experience.

In general, the system collects input from Case History, which lists the documents filed in the case. An artificial intelligence engine identifies the most recent filed document and provides pointers that help the user determine what to do next in the case. The system puts the user through training case analysis (Counts), legal research, and document creation. The output is properly formatted documents, for example, a PDF. Once the document is filed and Case History updated, the system responds to this change with new pointers. The cycle repeats until the user gets a judgment or settlement.

The cyclical steps—training, case analysis, legal research, and document creation—may not always be linear nor is each always required in a flow. Rather, each step is based on a user's decisions about their needs. Using such a process, user's come to understand the circular nature of civil procedure and the importance of filing the right documents at the right time in the right order. Thus, some embodiments of the present inventive concept distribute legal information and knowledge in such a way as to improve the average non-represented litigant's performance in a complex civil case.

Using a civil lawsuit as the example, in a civil case, a pro se party generally needs to know two things: (1) what to do; and (2) how to do it. Embodiments of the present inventive concept provide methods and systems for improving the overall performance of pro se parties in, for example, complex civil cases, by enabling them to answer legal questions on their own, thereby guiding them through the civil legal process. In some embodiments, The method relies on an integrated system that includes the following functionality: (1) an artificial intelligence engine that points users to resources based on the stage they are in the case; (2) video lessons and embedded instructions; (3) a case analysis feature that facilitates identification of elements of claims and defenses, case events, and supporting evidence; (4) a case history feature that simulates a court docket; (5) a searchable case database; (6) and guided templates for writing lawyer-like documents.

Referring first to FIG. 21, a simple flow diagram describing the system will be discussed. As illustrated therein, operations begin at block 1500 by collecting data/information from a user, including, for example, case information, party information, case history, events (facts of the case) and the like. The data collected is used to determine pointers (block 1510) that will be provided to help the user determine what to do next in the case. The pointers are output (block 1510) to the user to guide the user through appropriate training. The training also helps users determine what to do next. After training, the system sends the user through case analysis (block 1530) (Counts), this process allows the user to determine the viability of claims and defenses in the case and what to do next by narrowing down the elements they must prove or disprove. After case analysis (block 1530), the system guides the user through Laws (block 1540), where the user finds legal authorities that support their various positions or arguments.

Finally, the user is guided through a document workflow process (block 1550). Information during the document workflow process is essential to helping the user determine how to write legal documents. The document workflow process ends with the creation of a ready-to-file document (block 1560), for example, a PDF. Embodiments of the present inventive concept is not limited to the PDF format. The formatted document is filed and the case updated (block 1570). Then, it is determined if a judgment or settlement in the matter (block 1580). If there has been a judgment or settlement (block 1580), operations cease. If, on the other hand, no judgment or settlement has been found (block 1580), operations return to block 1500 and repeat until a terminating event, like settlement and judgment, is detected.

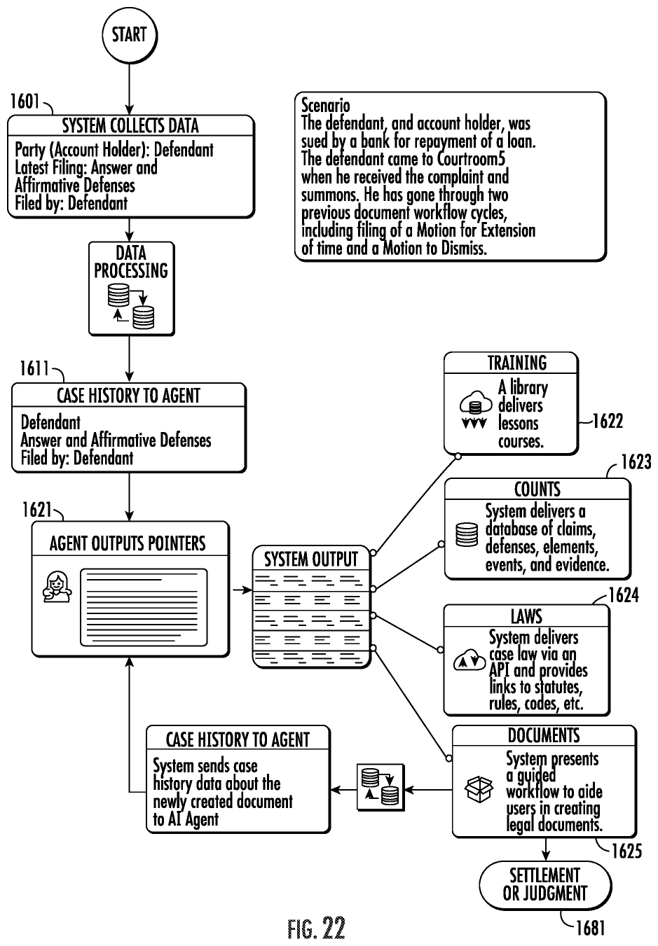

Referring now to FIG. 22, a more detailed flowchart illustrating processing steps in accordance with some embodiments of the present inventive concept will be discussed. The statement of the case is as follows. A defendant, and account holder (customer), was sued by a bank for repayment of a loan. The defendant came to Courtroom5 (the legal toolbox in accordance with embodiments discussed herein) when he received the initial complaint and summons. He has gone through two previous document workflow cycles, including filing of a Motion for Extension of time and a Motion to Dismiss.

As illustrated in FIG. 22, in embodiments illustrated therein, operations begin at block 16-1 by collecting data. To help this defendant, the system uses information already gathered during intake including, party information (account holder—defendant), as well as the account holder information so that pointers are relevant to that account holder. This information rarely changes, what does change, however, is what's been filed (Latest Filing—block 1601), by whom (Filed by) and when. This information is stored in “Case History,” which manages a list of documents filed in the case by date. This allows the system to determine if there has been a change in the case that requires action on the part of the defendant. In the scenario illustrated in FIG. 21, a document, Answer and Affirmative defenses, has been filed by the Defendant.

The information from Case History (block 1611) is processed, and a processor, for example, an AI engine identifies the most recent filed document. In this case, the defendant's Answer and Affirmative Defenses. Based on what's been filed, the system outputs to the dashboard pointers (block 1621) to resources to help the user determine what to do next. In some embodiments, the pointers may appear as an AI agent or bot in a top left corner of the user's dashboard. In these embodiments, on the dashboard, all the resources are easily available to the user. In FIG. 16, the AI agent offers the following pointers: Did you know that affirmative defenses can be amended based on what is found in discovery? You can learn more about the discovery process in the lessons, (1) Conducting Discovery, (2) Strategy at the Discovery Stage, and (3) Responding to and Reviewing Discovery. This “TRAINING” (block 1622) can be found in the library. COUNTS (block 1623) can be used to analyze the case and determine the facts (events) and evidence you need to collect. LAWS (block 1624) can be used to gather information about how to draft requests for interrogatories, documents, admissions in your jurisdiction and the like. Once a user is ready to create documents, DOCUMENTS (block 1625) can be used to create a document that is ready to file.

In DOCUMENTS (block 1625), templates may be used to guide users through creation of, for example, a motion, pleading, notice, and the like and a properly formatted legal document may be created. Links are provided to filing instructions, prompts are provided to the user to update Case History (block 1611) and respond to the change in Case History with new pointers. The workflow may repeat as illustrated in FIG. 16 until a terminating event is detected, for example, if the user gets a judgment or settlement (block 1681).

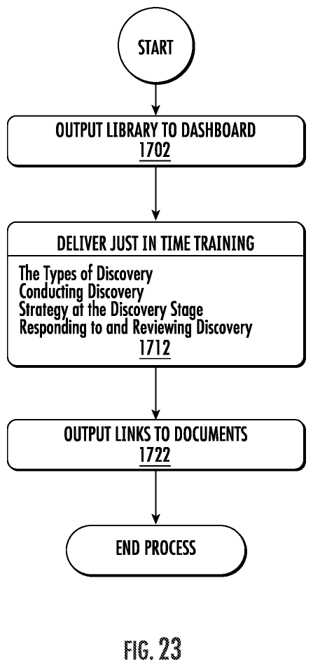

Referring now to FIG. 23, a general workflow diagram illustrating processing steps in training during a discovery stage of litigation in accordance with some embodiments of the present inventive concept will be discussed. With the update of Case History, suggestions of training from the library on the user's dashboard are provided (block 1702). Lessons, for example, video lessons, are delivered to the user that are suggested by the AI agent (block 1712). The suggested lessons are “just in time” as they are relevant to the next document(s) that need to be created for the case. The process is designed to help the user determine what to file next and how. In the example, illustrated in FIG. 23, three lessons are suggested, Conducting Discovery, Strategy at the Discovery Stage, and Responding to and Reviewing Discovery. In one instance, the user may apply understanding from training into use of the COUNTS feature to determine claims or defenses. Alternatively, the user may apply the understanding to searching in LAWS for cases that support their legal arguments. Similarly, they may apply TRAINING, COUNTS and LAWS to drafting a document (block 1722), such as an Answer and Affirmative Defenses.

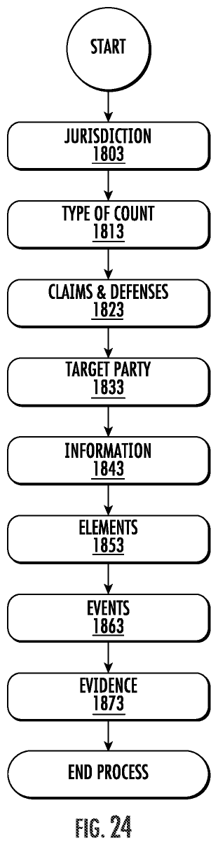

Referring now to FIG. 24, a simple workflow diagram illustrating processing steps for adding a Count (claim or defense) in accordance with some embodiments of the present inventive concept will be discussed. The COUNTS module helps the user analyze their case by connecting claims and defenses to elements, events (facts) and evidence in the case. As illustrated in FIG. 18, in order, the system collects information about jurisdiction (block 1803), the type of Count (claim or defense) (block 1813), the name of the claim or defense (1823), and the party that the Count targets (block 1833). Once the data is collected, the system outputs information (block 1843) about the chosen claim or defense. Then, elements (block 1853) are output and data is collected for events (block 1863) and evidence (block 1873).

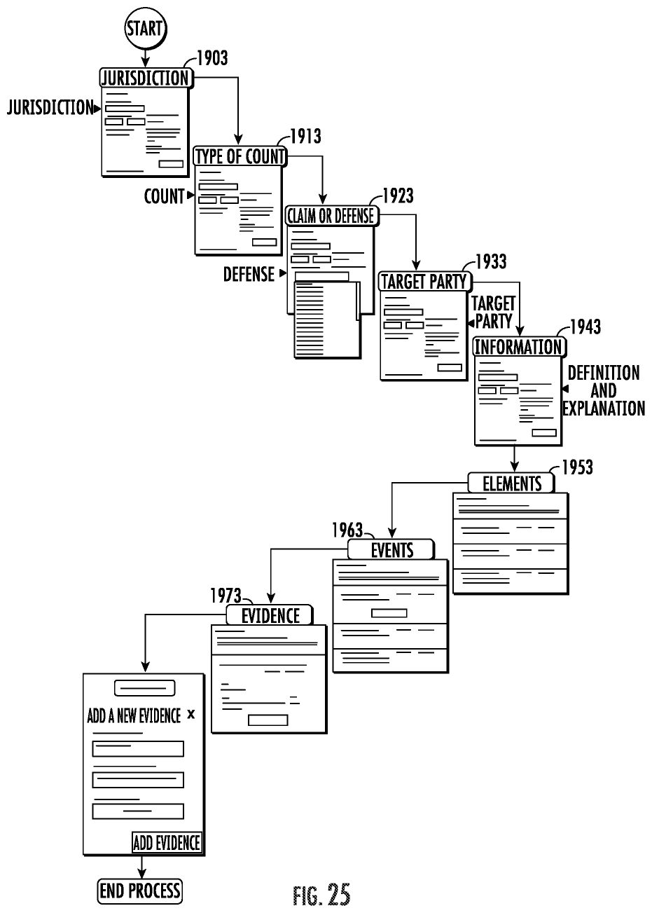

Referring now to FIG. 25, an example of how the flow of FIG. 24 actually works in context will be discussed. As illustrated in FIG. 25, the defendant wants to support a defense of “Breach of Contract” by Plaintiff in Delaware. When the Counts feature is selected, the system presents a choice of jurisdictions (block 1903) with the account holder's jurisdiction preselected. This allows the account holder to accept the default jurisdiction or select another. In embodiments illustrated in FIG. 25, the defendant selects “Delaware.” Once the jurisdiction is selected, the system presents a two-button choice for type of Count, claim and defense (block 1913). If the user chooses claim, s/he will be presented with possible claims, for example, “Breach of Contract” or “Defamation”. If s/he chooses defenses, s/he might be presented with “Laches” or “Failure of Conditions Precedent” and so on. In the current example, the defendant selects the defense, “Breach of Contract by Plaintiff” When the claim or defense is selected (block 1923), the system presents a list of parties in the case and prompts the user to select the party that the claim or defense is against (block 1933).

The system outputs information (block 1943) about the chosen claim or defense, including a definition of the claim, a simplified definition, the elements of that claim or defense, and a source for the elements. The source is either an appellate case, a statute or rule, or jury instructions. The system also tracks the user's progress and lets them know at a glance how complete the Count is. For each element (block 1953), the system prompts the user to select from a list of case events (block 1963) that have been input into the system. Or they can add new events. The system prompts the user for evidence of each event and provides a means for them to upload images and, for example, PDFs for this purpose. For a complete analysis, the user repeats the process until all the elements have events with evidence (block 1973), and the completeness tracker reads “Complete”. In some embodiments it may take a user multiple cycles before the task is complete.

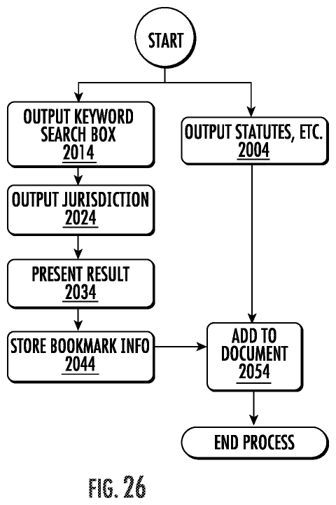

Referring now to FIG. 26, a general workflow diagram for using a LAWS lookup module in accordance with some embodiments of the present inventive concept will be discussed. The LAWS module/feature outputs a searchable database of appellate cases and links to statutes, rules, and the like (block 2004). In some embodiments, a search box (block 2014) allows the user to conduct a simple or complex keyword search, and a filter allows users to select one or more jurisdictions to search (block 2034). Generally, the jurisdiction of the account holder is the default selection. The user can change the selection or add a jurisdiction.

In some embodiments, results of the search are output to the user with keywords highlighted. The user can review the results as a list, refine the search, or conduct a different search. If a case seems particularly interesting, they can expand it for closer review. A bookmark feature allows the user to store relevant cases for later use (block 2044). In some embodiments, to store a bookmark, the user is prompted to identify the issue or main point in the case, to give it a title, and to provide a citation. Eventually, the user will have a collection of bookmarks describing the appellate cases they need. The user can later copy and paste from bookmarks into a document they are creating if necessary.

It will be understood that operations discussed above with respect to FIG. 26 are provided for example only and, therefore, embodiments of the present inventive concept are not limited thereto.

Document creation is a centerpiece of embodiment discussed herein. It is the ultimate goal of each user at the beginning of a cycle and the answer to the user's main question—What do I do next? The answer typically is “Write a document.” Which document to write and eventually file is ultimately answered with TRAINING, COUNTS, AND LAWS. By the time a user gets to document creation, there is only one question left—How do I do it? In short, document creation brings all parts of the process together.

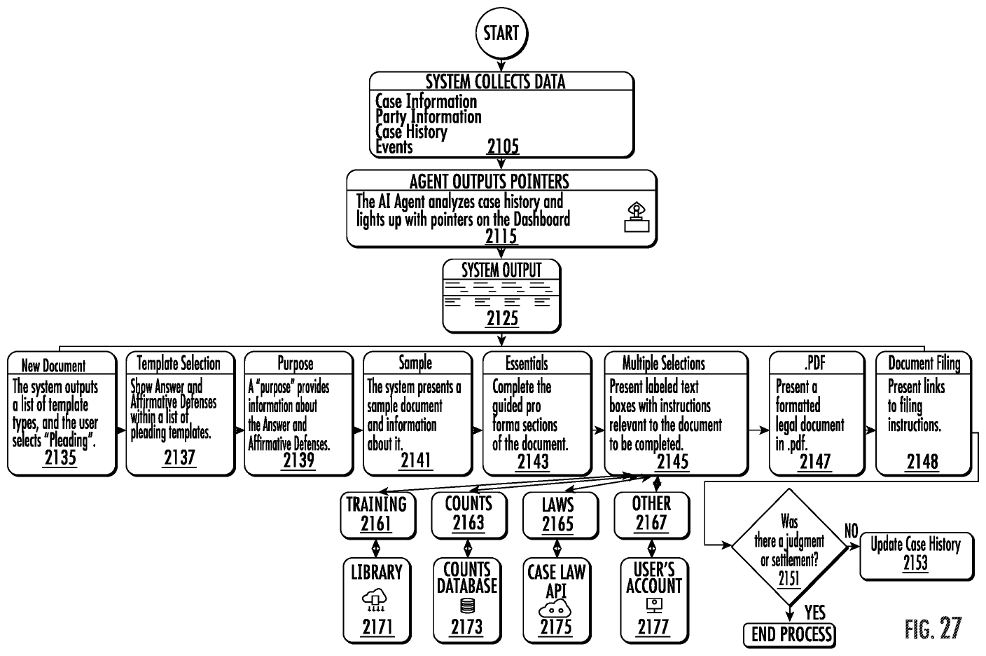

Referring now to FIG. 27, a detailed workflow diagram for document creation in accordance with some embodiments of the present inventive concept will be discussed. As discussed above, when a document has been filed in the case and Case History has been updated (block 2105). At that point, the AI outputs pointers (block 2115) to training, case analysis, legal research, and document creation.

In some embodiments, the document creation workflow begins with the output of template types (block 2135), including, for example, motions, notices, pleadings, discovery, and the like. In embodiments illustrated in FIG. 27, the user selects “Pleading”. From the list of pleading templates, they select Answer and Affirmative Defenses (block 2137). A “Purpose” statement (block 2139) provides information about the Answer and Affirmative Defenses, and a sample document (block 2141) shows what the Answer and Affirmative Defenses might look like when it is complete. After the user learns about the desired document (block 2143), the template for the Answer and Affirmative Defenses is presented to the user in multiple sections (block 2145).

In some embodiments, the guided pro forma section of the document includes information that is consistent on every legal document, such as the wording in the Certificate of Service. The customized areas of the template consist of text boxes with instructions and headings relevant to the document to be completed. For the Answer and Affirmative Defenses template, the user is presented with text box sections labelled introduction, additional statements, answer, and affirmative defenses. These sections depend on the parts expected or required in the document being created.

Underneath each text box section, the system outputs a toolbar with features that the user may need during completion of that specific section. For instance, for the Introduction section, the Laws tool may appear highlighted. That might prompt the user to find the statute the document relies on. Features might include TRAINING (2161) and library 2171, COUNTS (2163) and counts database 2173, and LAWS (2165) and Case law API 2175 as well as CASE HISTORY (2167) and user account 2177 and other features. Thus, the system can deliver, for example, courses from within the documents feature and facilitate creation and editing of COUNTS. When the template is complete, the system outputs edit features that allow the user to go back and correct mistakes. When there are no corrections to make, the system presents a button for the user to generate a final document, for example, a PDF of the document (block 2147).

Finally, the system presents links to filing instructions in any jurisdiction (block 2148). The user may file the document either electronically or in person. If there is no settlement or judgment (block 2151), the system prompts the user to update “Case History” (block 2153). The user updates case history by typing in the title and category of the newly filed document. The system processes the case history data and sends it to the artificial intelligence agent, and the cycle repeats until a termination event is detected.

As discussed above, some embodiments of the present inventive concept provide legal information and knowledge in such a way as to improve the average unrepresented litigant's performance in a complex civil case. In some embodiments, the process consists of a system that monitors a court case, captures the status of the case, at each stage—complaint, answer, discovery, trial, and appeal—and responds with relevant training and directions for the use of specific software features.

A user may encounter many cycles during the litigation process. With each cycle, users experience the same general process until their case is resolved with a judgment or settlement. This instills in them the knowledge that the civil litigation system has a cyclical pattern of filings, responses, research, hearings, and repeat. In four steps—training, case analysis, legal research, and document creation—a user comes to understand this circular process and the importance of filing the right documents at the right time in the right order.

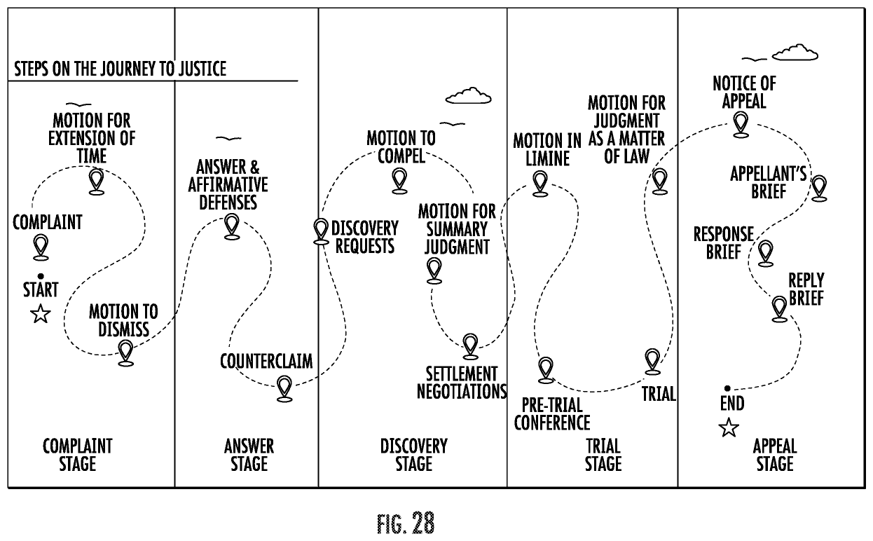

Referring now to FIGS. 28 through 36, an example scenario including use of embodiments discussed herein will be discussed. A user's need for tools in accordance with embodiments of the present inventive concept arise when the person has been sued or has sued someone else. An unrepresented person needs help navigating the maze of a lawsuit, in this example, civil case. Some embodiments of the present inventive concept discussed herein provide the tools for the user to become a successful pro se litigant.

Referring now to FIG. 28, a diagram illustrating the various stages of a court case will be discussed. Litigation is a journey. At each stage of your case, there are things a party, defendant or plaintiff, should expect to see or do. For example, the party should expect to see a complaint or a petition at the start of a case (complaint stage). At the answer stage, look for an answer, affirmative defenses, or even a counterclaim. A motion to compel is expected at the discovery stage. At the trial stage, a motion in limina or for judgment as a matter of law should not come as a surprise. Finally, appealing a case starts with a notice of appeal and an appellant's brief. All of the stages and the various stop gaps are illustrated in FIG. 28. However, it will be understood that any detection of a “terminating event” may shortcut the process so that all stages are not traversed. For example, if the parties reach settlement or the case is dismissed, it may not make it all the way through trial and appeal. FIG. 28 illustrates a high level view of the litigation process. When viewed at a high level there is a simple, repeatable path that can be followed from beginning (complaint) to end of the case (trial or appeal), during every stage. Every time the case history of the case is updated, the path illustrated in FIG. 28 should be considered.

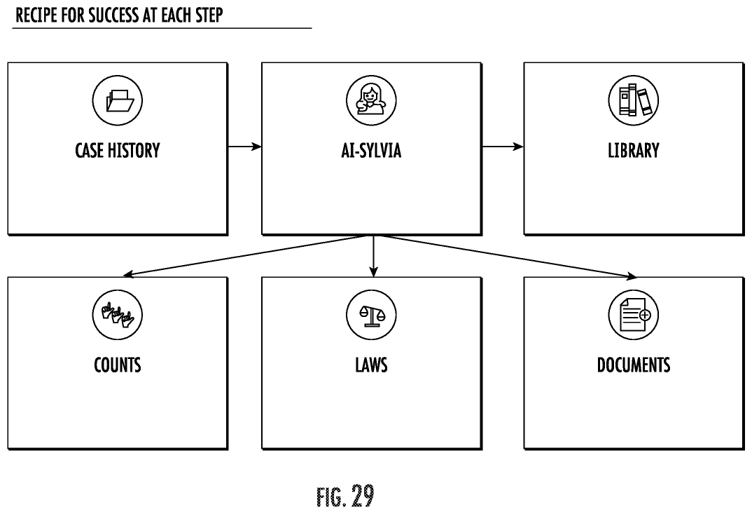

Referring now to FIG. 29, a diagram illustrating processes in accordance with embodiments discussed herein will be discussed. When an update in Case History is detected, the AI engine (Sylvia) may provide extra information about the paperwork that was just filed or suggest a step you should consider now. The next four recommended steps that can be taken in any order are: Training in the LIBRARY; analyzing your case with COUNTS; legal research with LAWS; and drafting the next filing with DOCUMENTS. It will be understood that these steps may be repeated at each step in the litigation process, for example, each time something is filed with the court.

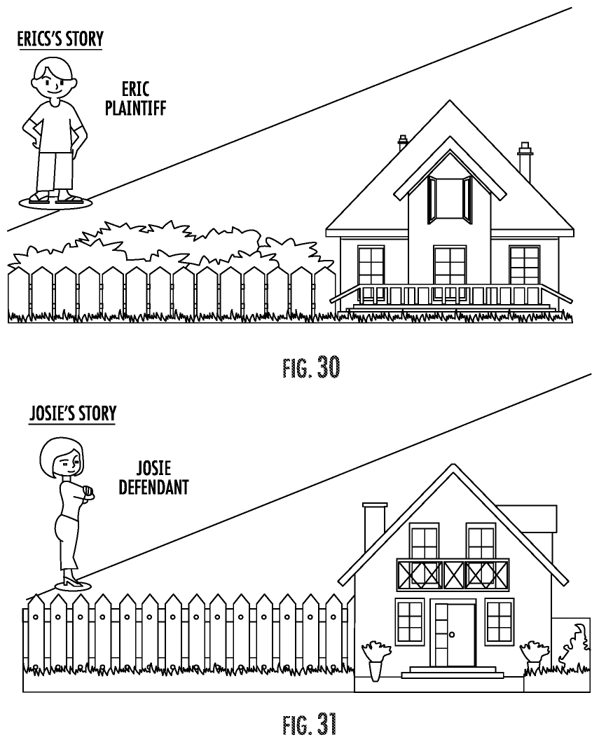

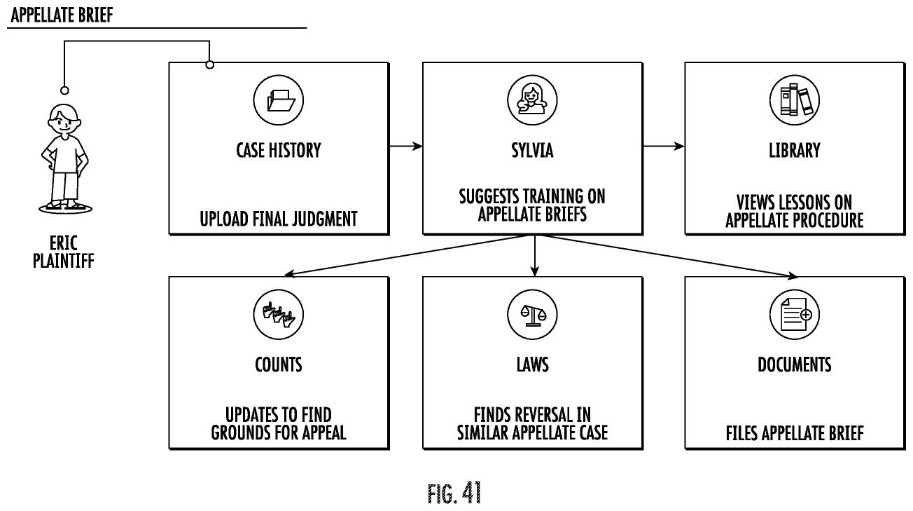

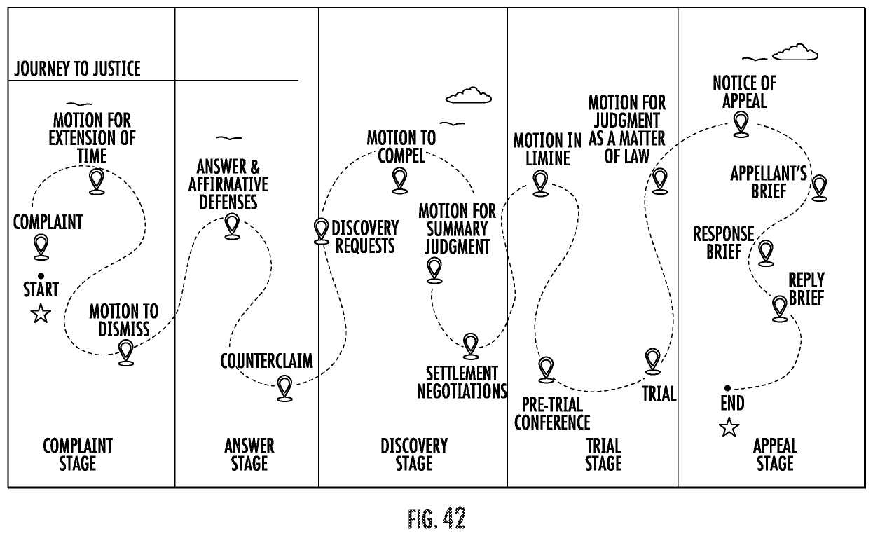

An example litigation will now be discussed with respect to FIGS. 30 through 42. As illustrated in FIG. 30, Plaintiff Eric has owned his house in Georgia for 26 years, having inherited it from his grandmother. The house is on a 4-acre plot of land with lots of well cared for trees, a garden, and even a koi pond. One day, to get a loan, Eric had the land surveyed. To his surprise, he discovered that he owned title to an adjacent quarter-acre plot of land that his neighbor, Josie, had been using as her own. He told Josie the land was his and to cease claiming it as hers. She refused and continued treating the property as her own. Six months after asking Josie to stop using the property, Eric filed a lawsuit against her for trespassing.

As illustrated in FIG. 31, Defendant Josie believes she owns the land adjacent to Eric's property. Over the last 22 years, Josie had improved the land by installing water pipes, building a fence and a shed, and keeping it in pristine condition. On occasion, she rented the property to tenants. When Eric filed suit against her, Josie vowed to fight for the land. She felt she should have title to it because she had claimed and improved the land for more than 20 years. She'd cared for the land while Eric had ignored it.

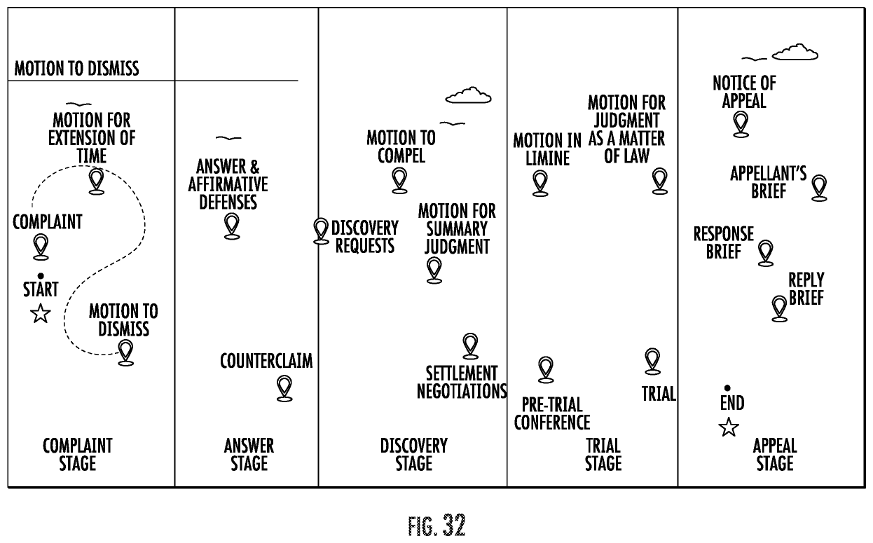

As illustrated in FIG. 32, after Eric filed his complaint to start the litigation, Josie responded to Eric's complaint with a motion for extension of time. This motion gives Josie more time to respond to Eric's complaint. A month after her motion was granted, she filed a motion to dismiss Eric's complaint for failure to state a claim. Josie contends that a notice of property boundary was required before the complaint was filed, attaching the official boundary of the tract in question. Her motion is based on the fact that Eric had not served her a property boundary notice, or even alleged as much in his complaint, and therefore his claim should be dismissed.

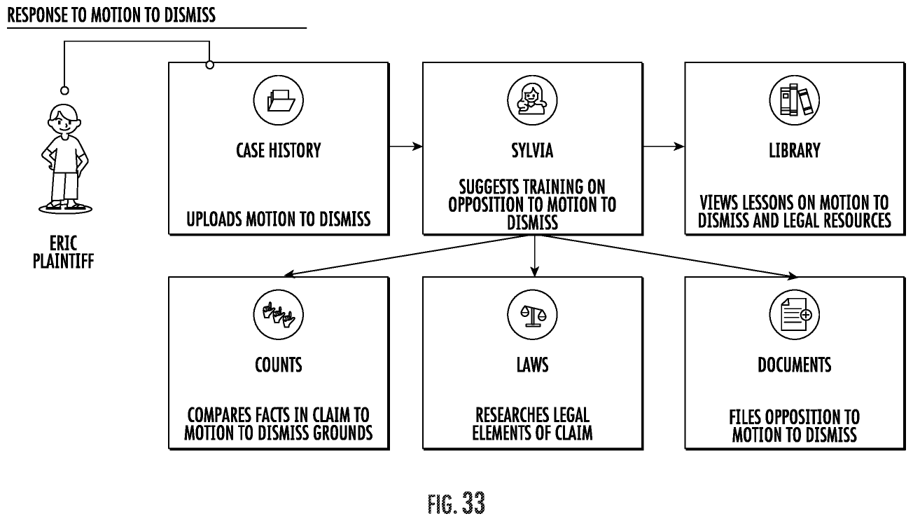

Referring now to FIG. 33, a diagram illustrating Eric's formulation of his response to the motion will be discussed. Using methods and systems discussed herein, Eric has to figure out how to respond to Josie's motion to dismiss his claim. The first thing Eric should do is update his case history with the motion he received from Josie. Then the AI agent provides any relevant suggestions. In this case, the AI agent information Eric of a video on opposing the Motion to Dismiss. Eric watches the suggested video using the LIBRARY. He also watches a video about legal research, knowing he will need to spend a lot of time researching the merits of his case. After finishing his research, he move to the COUNTS tool and compares the elements of his trespassing claim and his supporting facts to the assertions in Josie's motion. Eric can amend his trespassing complaint with any new information or leave it alone. Eric uses LAWS to go over the legal arguments of his claim and compares them to the legal arguments of Josie's claim. Eric decides to oppose Josie's motion to dismiss, so he uses DOCUMENTS to draft his response to Josie's motion to dismiss. Eric's response shows the court there's no notice requirement for his trespassing claim. The judge agrees with Eric and denies Josie's motion to dismiss.

As illustrated in the timeline of FIG. 33, after the judge denies Josie's motion to dismiss Eric's claim, he orders her to answer the complaint within 10 days. Josie now has to figure out how to plead her case.

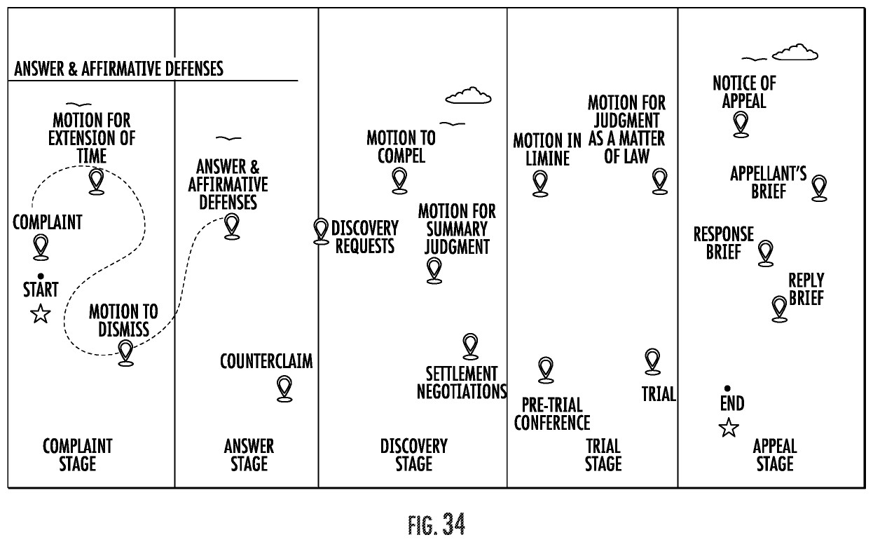

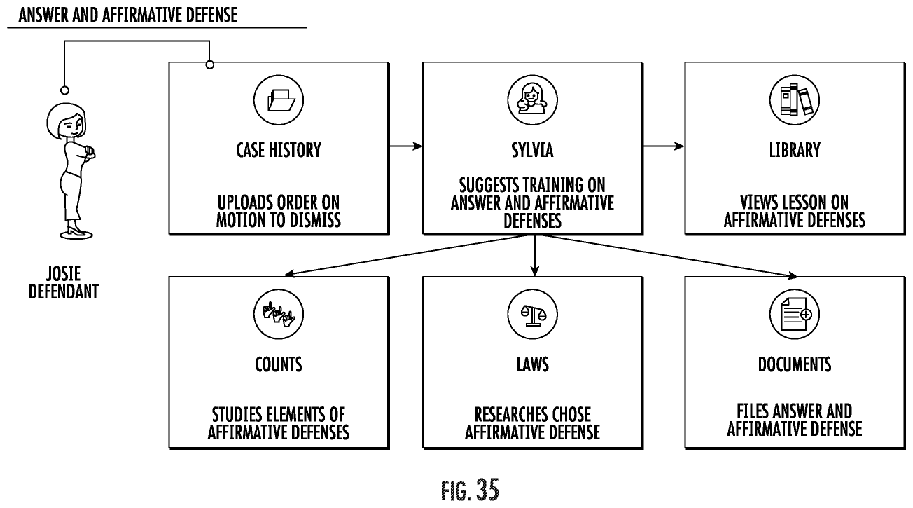

As illustrated in FIG. 34, first Josie uploads Eric's response to her Motion to Dismiss and the Judge's Order into her Case History. She then checks with the AI agent, Sylvia, for any suggestions. Sylvia suggests using COUNTS to further analyze her claim. Josie uses COUNTS to study the elements of several potential affirmative defenses and believes the affirmative defense of adverse possession will work best for her. Josie goes to LAWS to make sure her chosen affirmative defense is exactly what she needs. Next Josie wants to see if the LIBRARY gives her any other ideas or tips before she starts her answer. She watches videos on pleading an answer and affirmative defenses and decides she's on the right path. Josie uses DOCUMENTS to draft her answer and affirmative defense.

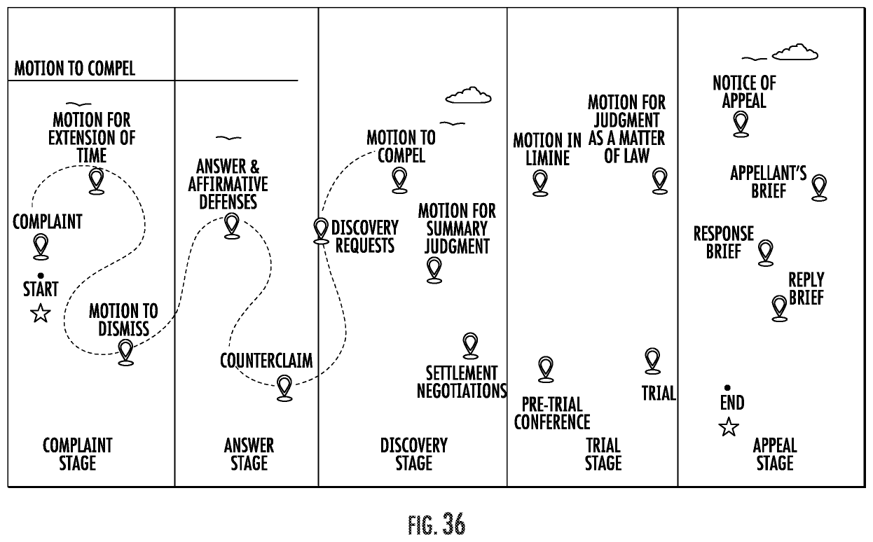

As illustrated in FIGS. 35 and 36, Eric and Josie are now in the thick of the discovery stage. Each has sent Requests for Interrogatories and Requests for Production of documents. Josie has sent Eric Requests for Admissions and has objected to many of his interrogatories. Josie has objected to 11 of the 32 questions Eric asked on his interrogatories, but she has turned over some evidence to support Eric's allegations. Eric wants to force Josie to answer all of his questions. Eric is concerned that he cannot prove his case at trial without them.

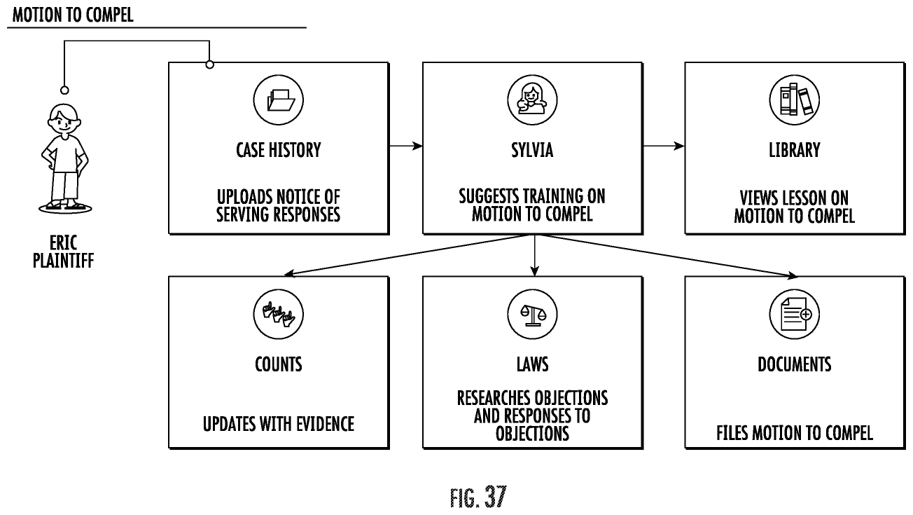

Referring now to FIG. 37, Eric uploads Josie's Notice of Serving Responses to his Request for Interrogatories and then checks with the AI agent, who suggests researching Josie's objections with Laws. Eric follows that suggestion and goes to LAWS. He gathers additional information about Josie's objections, which helps him find a legal basis to force Josie to answer his questions. Eric uses the LIBRARY and watches a video about the discovery process and a motion to compel. Eric then updates COUNTS with the evidence Josie provided. He also updates COUNTS to show that his questions to Josie were relevant and that Josie should answer them. He uses DOCUMENTS to draft his Motion to Compel and shows the relevance of his requests. He's able to tie each of his questions for Josie to specific facts he's alleged in his complaint. The judge agrees with Eric and compels Josie to respond adequately to his questions.

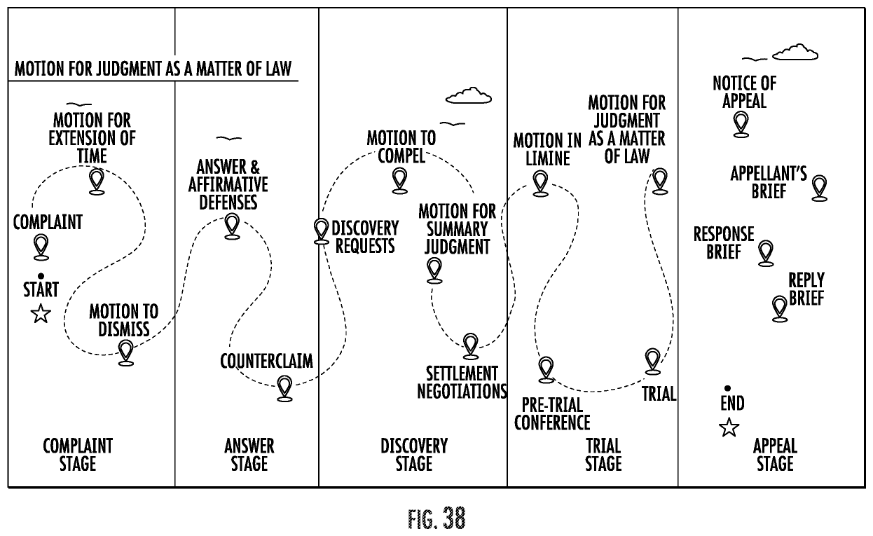

As illustrated in FIG. 38, Eric and Josie complete a lengthy discovery period and finally they get to trial, and Josie has rested her case. She believes that Eric had not presented enough evidence at trial to defeat her affirmative defense of adverse possession. She wonders if this case should even go to the jury. What does she do now?

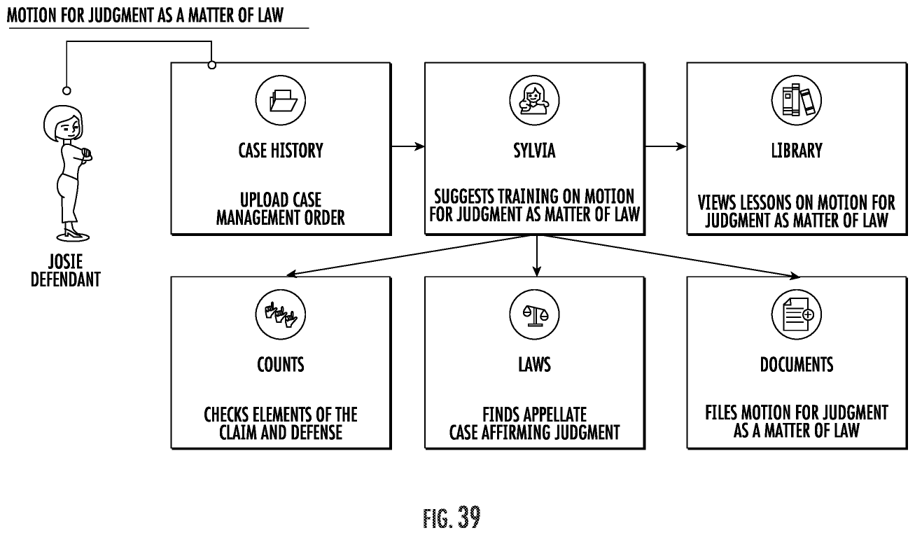

As illustrated in FIG. 39, Josie files the Jury instructions the Judge provided. The AI agent then suggests looking at the Document instructions for a Motion for Judgment as a Matter of Law. Josie checks the LIBRARY and watches videos on motions that can end a case. She watches another video specifically on a Motion for Judgment as a Matter of Law. Josie reviews her COUNTS tool and quickly confirms what she'd suspected. Despite the many statutes governing adverse possession in Georgia, Eric hadn't been able to deal a solid blow to any of her elements. She fulfills every element in her COUNTSs tool with facts and evidence!

She uses LAWS and finds supporting case law from 2014. This case is very similar to her own and the Georgia supreme court's ruling favored Josie's case. Eric had tried to knock out her exclusivity element by arguing that Josie occasionally rented the property to tenants, but his argument was contrary to the case law she'd read. Josie drafts a Motion for judgment as a matter of law in DOCUMENTS and files the motion. She argues her motion in court before the jury enters the courtroom. The judge agrees with her and rules in her favor. Josie has won the case!

Eric is deflated, but not yet defeated. He's not giving up. He feels Josie has trespassed on his property for more than two decades, and that the judge erred in not allowing the jury to decide it. He also blames the judge for barring evidence that Josie rented out the property to tenants. As illustrated in FIG. 39, Eric decides to appeal.

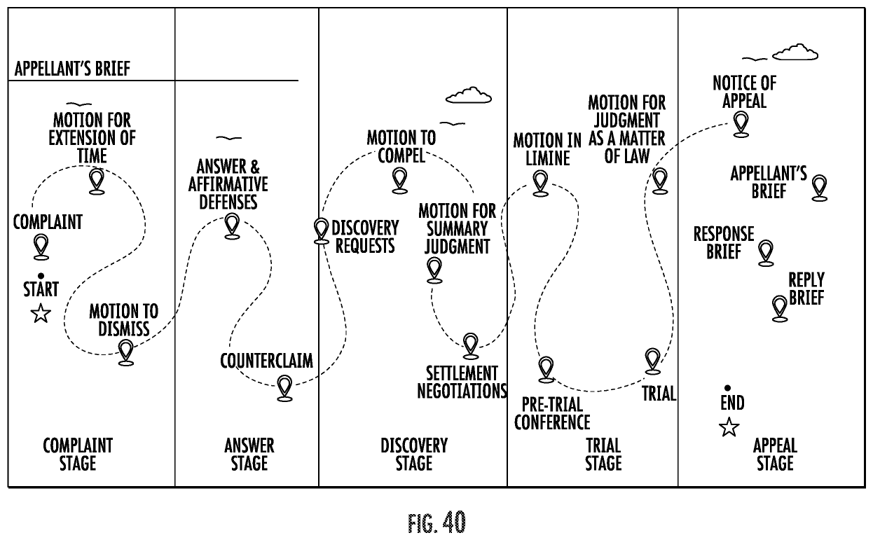

As illustrated in FIG. 40, Eric updates his Case History with the ruling. The AI agent suggests using DOCUMENTS for an appellate brief. He uses the LIBRARY and learns as much as he can about the appeals process. Next, Eric updates his COUNTS tool and sees gaps in the affirmative defense that Josie had used to win. Eric disagrees with how the judge interpreted the “exclusivity” requirement of that defense. Eric believes the exclusivity element refers to actual possession of the property, but Josie rented the property to others. He had evidence of the rentals, but the judge wouldn't admit it into evidence. The jury never heard evidence that would've won the case for him. He uses LAWS to find support for his position. He finds a Georgia supreme court case where a land company filed a quiet title action against a defendant and won on appeal because the defendant, like Josie in this case, had not always resided on the property in question. Eric uses the Appellate Brief template in the DOCUMENTS tool to write his brief. In the end, the appellate court did not agree with Eric. He has lost the case on appeal.

Litigation is a journey. Not every case is identical, but everyone is going in the same direction. So, more often than not, similar documents are filed with the court. The ability to analyze the case, develop a strategy, and carry out that strategy makes an unrepresented party more efficient and effective litigator and makes the journey to justice more fruitful in the end.

It will be understood that the scenario discussed above with respect to FIGS. 28 through 42 was provided as an example only and, embodiments of the present inventive concept are not limited thereto.

As will be appreciated by one of skill in the art, the inventive concept may be embodied as a method, data processing system, or computer program product. Accordingly, the present inventive concept may take the form of an entirely hardware embodiment or an embodiment combining software and hardware aspects all generally referred to herein as a “circuit” or “module.” Furthermore, the present inventive concept may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present inventive concept may be written in an object-oriented programming language such as Java®, Smalltalk or C++. However, the computer program code for carrying out operations of the present inventive concept may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part above with reference to a flowchart illustration and/or block diagrams of methods, systems and computer program products according to embodiments of the inventive concept. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A method for guiding a user through stages of a legal action, the method comprising:
receiving an update in status of a legal proceeding to update a case history of the legal proceeding;
providing information from an agent based on the update in status of the legal proceeding;
training the user on relevant portions of the legal proceeding based on the information provided from the agent;
receiving facts related to the legal proceeding and analyzing the relevant portions of the legal proceeding based on the received facts and training to provide analysis results;
preparing a document for filing with a court presiding over the legal proceeding using the analysis results; and
repeating the receiving an update, providing information, training the user, receiving facts and analyzing portions of the legal proceeding and preparing the document for every stage of the legal proceeding until an indication of a terminating event is received,
wherein at least one of the repeating the receiving an update, providing information, training the user, receiving facts and analyzing portions of the legal proceeding and preparing the document is performed by at least one processor.

2. The method of claim 1, wherein preparing the document for filing further comprises providing access to a system that delivers case law and links to statues, rules and codes used in preparing the document for filing.

3. The method of claim 2, wherein receiving facts related to the legal proceeding is followed by presenting statutes, rules of procedure and appellate opinions relative to the analysis results and training using the case law links to statutes, rules and codes.

4. The method of claim 1, wherein training comprises providing a library of lessons for use by the user on topics related to a particular stage of the legal proceeding.

5. The method of claim 1:
wherein receiving facts comprises receiving evidence from the user and storing the evidence in a database; and
wherein analyzing the relevant portions of the legal proceeding comprises providing a database including claims, defenses and elements stored in the database with the evidence provided by the user and providing an indication to the user which claims, defenses and/or elements are valid for the user to pursue.

6. The method of claim 1, wherein receiving an update in status comprises receiving an indication that one party to the legal action has filed a document with the court presiding over the legal proceeding.

7. The method of claim 1, wherein providing information from the agent comprises providing information from an artificial intelligence (AI) agent that guides the user to relevant training, laws and evidence to be used in preparing the document for filing with the court.

8. The method of claim 1, wherein a terminating event comprises at least one of a judgment issued by the court and a settlement between parties.

9. The method of claim 1, wherein the stages of the legal proceeding comprise one or more of complaint, answer, discovery, trial and appeal.

10. A system for guiding a user through stages of a legal action, the system comprising:
a processor; and
a non-transitory computer readable medium to store a set of instructions for execution by the processor, the set of instructions to cause the processor to:
receive an update in status of a legal proceeding to update a case history of the legal proceeding;
provide information from an agent based on the update in status of the legal proceeding;
train the user on relevant portions of the legal proceeding based on the information provided from the agent;
receive facts related to the legal proceeding and analyze the relevant portions of the legal proceeding based on the received facts and training to provide analysis results;
prepare a document for filing with a court presiding over the legal proceeding using the analysis results; and
repeat the receiving an update, providing information, training the user, receiving facts and analyzing portions of the legal proceeding and preparing the document for every stage of the legal proceeding until an indication of a terminating event is received.

11. The system of claim 10, wherein the set of instructions causes the processor to prepare the document for filing by providing access to a system that delivers case law and links to statues, rules and codes used in preparing the document for filing.

12. The system of claim 11, wherein the set of instructions causes the processor to present statutes, rules of procedure and appellate opinions relative to the analysis results and training using the case law links to statutes, rules and codes.

13. The system of claim 10, wherein the set of instructions causes the processor to train by providing a library of lessons for use by the user on topics related to a particular stage of the legal proceeding.

14. The system of claim 10:
wherein the set of instructions causes the processor to receive facts by receiving evidence from the user and storing the evidence in a database; and
wherein the set of instructions causes the processor to analyze the relevant portions of the legal proceeding by providing a database including claims, defenses and elements stored in the database with the evidence provided by the user and providing an indication to the user which claims, defenses and/or elements are valid for the user to pursue.

15. The system of claim 10, wherein the set of instructions causes the processor to receive an update in status by receiving an indication that one party to the legal action has filed a document with the court presiding over the legal proceeding.

16. The system of claim 10, wherein the set of instructions causes the processor to provide information from the agent by providing information from an artificial intelligence (AI) agent that guides the user to relevant training, laws, and evidence to be used in preparing the document for filing with the court.

17. The system of claim 10, wherein a terminating event comprises at least one of a judgment issued by the court and a settlement between parties.

18. The system of claim 10, wherein the stages of the legal proceeding comprise one or more of complaint, answer, discovery, trial and appeal.

19. A computer program product for guiding a user through stages of a legal action, the computer program product comprising:
a non-transitory computer readable storage medium having computer readable program code embodied in said medium, the computer readable program code comprising:
computer readable program code to receive an update in status of a legal proceeding to update a case history of the legal proceeding;
computer readable program code to provide information from an agent based on the update in status of the legal proceeding;
computer readable program code to train the user on relevant portions of the legal proceeding based on the information provided from the agent;
computer readable program code to receive facts related to the legal proceeding and analyze the relevant portions of the legal proceeding based on the received facts and training to provide analysis results;
computer readable program code to prepare a document for filing with a court presiding over the legal proceeding using the analysis results; and
computer readable program code to repeat the receiving an update, providing information, training the user, receiving facts and analyzing portions of the legal proceeding and preparing the document for every stage of the legal proceeding until an indication of a terminating event is received.

20. The computer program product of claim 17, wherein the computer readable program code to prepare the document for filing further comprises computer readable program code to provide access to a system that delivers case law and links to statues, rules and codes used in preparing the document for filing, the computer program product further comprising computer readable program code to present statutes, rules of procedure and appellate opinions relative to the analysis results and training using the case law links to statutes, rules and codes.
